(19) United States
(12) Patent Application Publication
(10) Pub. No.: US 2018/0257502 A1
(43) Pub. Date: Sep. 13, 2018

(54) WIRELESS CHARGING SYSTEM FOR UNMANNED AERIAL VEHICLE AND METHOD FOR OPERATING SAME

(71) Applicant: LG INNOTEK CO., LTD., Seoul (KR)

(72) Inventor: Sung Soo PARK, Seoul (KR)

(73) Assignee: LG INNOTEK CO., LTD., Seoul (KR)

(21) Appl. No.: 15/761,311

(22) PCT Filed: Sep. 29, 2016
(86) PCT No.: PCT/KR2016/010894

§ 371 Date: Mar. 19, 2018

(30) Foreign Application Priority Data
Oct. 1, 2015 (KR) 10-2015-0138373
Oct. 6, 2015 (KR) 10-2015-0140291
Oct. 6, 2015 (KR) 10-2015-0140292

(51) Int. Cl. B60L 11/18; B64C 39/02; H02J 7/02; H02J 50/90; H02J 50/80; H02J 50/12

(52) U.S. Cl. CPC B60L 11/1829; B64C 39/024; B60L 11/182; B60L 11/1838; B60L 11/1833; B64C 2201/042; H02J 50/90; H02J 50/80; H02J 50/12; B60L 2200/10; B64C 2201/024; H02J 7/025

(57) ABSTRACT

A driving method of an unmanned aerial vehicle according to an embodiment may include moving, by the unmanned aerial vehicle, based on GPS information, receiving a wireless signal including position information about a charging apparatus from the charging apparatus, determining whether the GPS information matches the position information included in the wireless signal and landing based on the GPS information and the wireless signal, transferring a reception packet including power information about the unmanned aerial vehicle to the charging apparatus, and receiving precise position information including position coordinates of the charging apparatus generated based on the reception packet.

### TECHNICAL FIELD

The present invention relates to a wireless charging system for unmanned aerial vehicles and a driving method thereof.

### BACKGROUND ART

Wireless power transmission or wireless energy transfer technology is technology which wirelessly transmits energy from a transmitter to a receiver by using the magnetic field induction principle. Electric motors or transformers using started to be used in 1800s, and since then, a method of radiating electromagnetic waves such radio waves or laser to transmit energy has been attempted. The wireless power transmission technology may be variously used in whole industry such as information technology (IT), railway, and appliance industries as well as mobile.

Unmanned aerial vehicles fly by using a self-flight control apparatus or through remote control without pilot's being boarded thereon, and thus, are very high in availability in that the unmanned aerial vehicles perform tasks, which is difficult or risk for a person to directly, such as anchoring, freight transport, forest fire observation, radiation detection, etc. However, since it is not easy to supply power to the unmanned aerial vehicles, there is a problem where the unmanned aerial vehicles are difficult to fly for a long time.

### DISCLOSURE

### Technical Problem

A technical object of the present invention is to provide a wireless charging system for unmanned aerial vehicles with enhanced wireless charging efficiency and an operating method thereof.

### Technical Solution

A driving method of an unmanned aerial vehicle according to an embodiment may include moving, by the unmanned aerial vehicle, based on GPS information, receiving a wireless signal including position information about a charging apparatus from the charging apparatus, determining whether the GPS information matches the position information included in the wireless signal and landing based on the GPS information and the wireless signal, transferring a reception packet including power information about the unmanned aerial vehicle to the charging apparatus, and receiving precise position information including position coordinates of the charging apparatus generated based on the reception packet.

A driving method of a charging apparatus according to an embodiment may include transferring a wireless signal including AP information about the charging apparatus to an unmanned aerial vehicle, sensing the unmanned aerial vehicle to transfer a digital signal and receiving a reception packet from the unmanned aerial vehicle, and determining whether to align, based on reception power information of a wireless power reception apparatus included in the reception packet.

A driving method of a charging apparatus according to an embodiment transferring a wireless signal including AP information about the charging apparatus to the unmanned aerial vehicle, performing IR-UWB communication with the unmanned aerial vehicle to measure a position of the unmanned aerial vehicle, transferring position measurement information and a digital signal to the unmanned aerial vehicle, receiving a reception packet from the unmanned aerial vehicle, determining whether to align, based on reception power information of a wireless power reception apparatus included in the reception packet, and sensing, by an electronic textile sensor of the charging apparatus, the unmanned aerial vehicle.

A driving method of an unmanned aerial vehicle according to an embodiment may include moving, by the unmanned aerial vehicle, based on GPS information, receiving a wireless signal including position information about a charging apparatus from the charging apparatus, determining whether the GPS information matches the position information included in the wireless signal, performing IR-UWB communication with the charging apparatus, and landing based on the position measurement information received from the charging apparatus.

### Advantageous Effects

According to an embodiment, a wireless charging module is disposed in a landing unit of an unmanned aerial vehicle, thereby enhancing charging efficiency.

Moreover, whether to land the unmanned aerial vehicle and a wireless power transfer apparatus are selected by using an electronic textile sensor of a charging apparatus, thereby enhancing charging efficiency.

Moreover, accurate landing of the unmanned aerial vehicle can be induced through positioning using an IR-UWB communication scheme.

Moreover, the wireless power transfer apparatus is activated or moved based on a landing point of the unmanned aerial vehicle, thereby enhancing charging efficiency.

### DESCRIPTION OF DRAWINGS

FIG. 1 is a magnetic induction equivalent circuit.

FIG. 2 is a magnetic resonance equivalent circuit.

FIGS. 3A and 3B are block diagrams illustrating a wireless power transfer apparatus as one of subsystems configuring a wireless power transfer system.

FIG. 4 is a block diagram illustrating a wireless power reception apparatus as one of the subsystems configuring the wireless power transfer system.

FIG. 5A is a diagram describing a wireless charging system for unmanned aerial vehicles according to an embodiment, and FIG. 5B is a diagram describing a wireless charging system for unmanned aerial vehicles according to another embodiment.

FIG. 6 is a front view of an unmanned aerial vehicle according to an embodiment.

FIG. 7 is a perspective view of an unmanned aerial vehicle according to another embodiment.

FIG. 8A is a system block diagram of an unmanned aerial vehicle according to an embodiment, and FIG. 8B is a system block diagram of an unmanned aerial vehicle according to another embodiment.

FIG. 9 is a diagram describing a wireless charging system for unmanned aerial vehicles according to another embodiment.

FIG. 10 is a diagram describing a wireless charging system for unmanned aerial vehicles according to another embodiment.

FIGS. 11A and 11B are diagrams describing a wireless charging system for unmanned aerial vehicles according to another embodiment.

FIG. 12 is a diagram describing a wireless charging system for unmanned aerial vehicles according to another embodiment.

FIG. 13 is a system block diagram of a charging apparatus according to an embodiment.

FIG. 14 is a system block diagram of a charging apparatus according to another embodiment.

FIG. 15 is a flowchart describing a driving method of an unmanned aerial vehicle according to an embodiment.

FIG. 16 is a flowchart describing a driving method of a charging apparatus according to an embodiment.

FIG. 17 is a flowchart describing a driving method of a charging apparatus according to another embodiment.

FIG. 18 is a flowchart describing a driving method of a charging apparatus according to another embodiment.

FIG. 19 is a flowchart describing a driving method of a charging apparatus according to another embodiment.

FIG. 20 is a system block diagram of a charging apparatus according to an embodiment.

FIG. 21 is a flowchart describing a driving method of a charging apparatus according to an embodiment.

FIG. 22 is a flowchart describing a driving method of a charging apparatus according to another embodiment.

FIG. 23 is a system block diagram of a charging apparatus according to an embodiment.

FIG. 24 is a flowchart describing a driving method of an unmanned aerial vehicle according to an embodiment.

FIG. 25 is a flowchart describing a driving method of an unmanned aerial vehicle according to another embodiment.

FIG. 26 is a flowchart describing a driving method of a charging apparatus according to an embodiment.

FIG. 27 is a flowchart describing a driving method of a charging apparatus according to another embodiment.

### MODE FOR INVENTION

Hereinafter, a wireless power transfer system including a wireless power transfer apparatus including a function of wirelessly transmitting power and a wireless power reception apparatus for wirelessly receiving power, according to an embodiment, will be described in detail with reference to the drawings. Embodiments described herein are provided so that this disclosure is thorough and complete and fully conveys the inventive concept to those skilled in the art. Therefore, the present invention is not limited to below-described embodiments and may be embodied in various forms. Also, in the drawings, a size, a thickness, and the like of an apparatus may be exaggerated and illustrated for convenience. Like numbers refer to like elements throughout.

An embodiment may include a communication system which selectively uses various kinds of frequency bands from a low frequency (50 KHz) to a high frequency (15 MHz) for wireless power transfer and may exchange data and a control signal for system control.

An embodiment may be applied to various industry fields such as portable terminal industry, smartwatch industry, computer and notebook industry, appliance industry, electric vehicle industry, medical apparatus industry, and robot industry which use an electronic device using or requiring a battery.

An embodiment may consider a system for transmitting power to one or more devices by using one or a plurality of transmission coils.

According to an embodiment, a problem where a battery is sufficient in smartphones, notebooks, etc. can be solved, and for example, when a smartphone or a notebook is used in a state where a wireless charging pad is located on a table, a battery may be automatically charged and thus may be used for a long time. Also, if the wireless charging pad is installed at a public place such as cafe, airport, taxi, an office, or a restaurant, various mobile devices may be charged irrespective of different charging terminals manufactured by different mobile device manufacturers. Also, if wireless power transfer technology is applied to home appliances such as vacuum cleaners and electric fans, it is not required to find a power cable, complicated electric cables are removed in home, lines in buildings are reduced, and the use of a space can increase. Also, in a case where an electric car is charged with current power for home, much time is expended. However, if a high power is transferred through the wireless power transfer technology, a charging time can be reduced, and if wireless charging facilities are installed on a floor of a parking lot, inconvenience where a power cable should be provided near an electric vehicle can be solved.

Terms and abbreviations described in an embodiment are as follows.

A wireless power transfer system: a system for providing wireless power transfer in a magnetic field area.

A wireless power transfer apparatus (a wireless power transfer system-charger): an apparatus which provides wireless power transfer to a power receiver in the magnetic field area and manages a whole system.

A wireless power reception apparatus (a wireless power transfer system-device): an apparatus which is provided with wireless power transfer from a power transmitter in the magnetic field area.

A charging area: an area in which actual wireless power transfer is performed in the magnetic field area, and the charging area may be changed based on a size of an application product, a required power, and an operating frequency.

An S parameter: the S parameter is a ratio of an input voltage to an output voltage in a frequency distribution and is a ratio (transmission; S21) an input port to an output port or a reflection value of each of input/output ports, namely, a value (reflection; S11 and S22) of an output reflected based on an input.

A quality factor (QA): a Q value in resonance denotes the quality of a frequency selection, and as the Q value increases, a resonance characteristic is good. The Q value is expressed as a ratio of stored energy to lost energy in a resonator.

To describe the principle that wirelessly transfers power, the wireless power transfer principle includes a magnetic induction method and a magnetic resonance method.

The magnetic induction method is non-contact energy transfer technology where a source inductor Ls is close to a load inductor Ll, and an electromotive force is generated in the load inductor Ll by using a magnetic flux which is generated when a current flows to the source inductor Ls. Also, the magnetic resonance method is technology where two resonators are coupled, magnetic resonance is performed by a natural frequency between the two resonators, and energy is wirelessly transferred by using a resonance technique where an electric field and a magnetic field are generated in the same wavelength range.

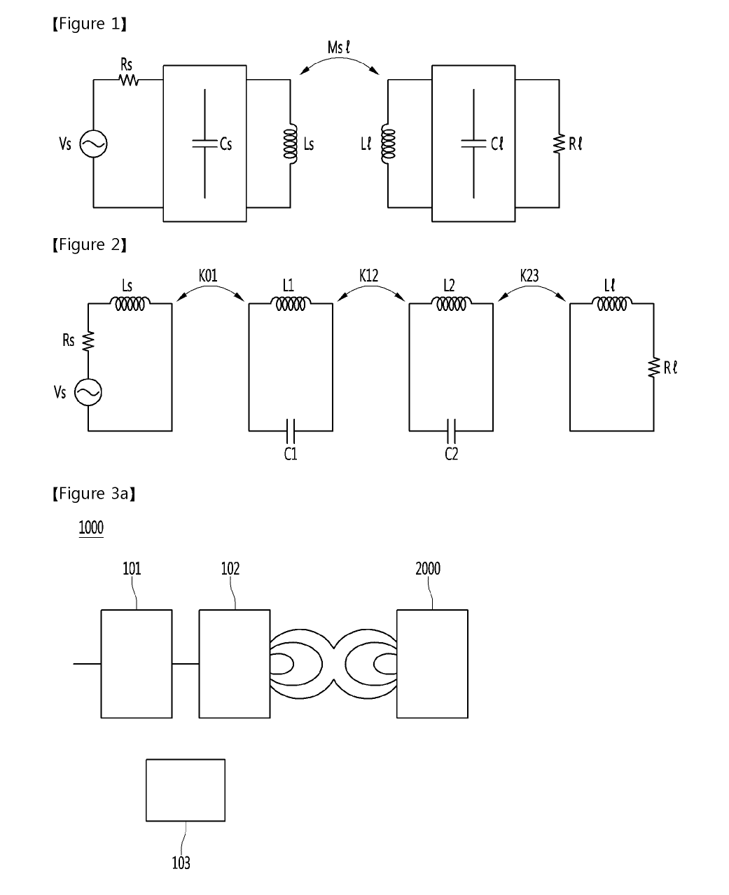

FIG. 1 is a magnetic induction equivalent circuit.

Referring to FIG. 1, in the magnetic induction equivalent circuit, a wireless power transfer apparatus may be implemented with a source voltage Vs based on an apparatus for supplying power, a source resistor Rs, a source capacitor Cs for impedance matching, and a source coil Ls for magnetic-coupling to a wireless power reception apparatus. The wireless power reception apparatus may be implemented with a load resistor R [symbol] which is an equivalent resistor of the wireless power reception apparatus, a load capacitor C [symbol] for impedance matching, a load coil L [symbol] for magnetic-coupling to the wireless power transfer apparatus, and a magnetic coupling degree of the source coil Ls and the load coil L [symbol] may be represented as a mutual inductance Msl.

In FIG. 1, a ratio S21 of an input voltage to an output voltage is calculated from the magnetic induction equivalent circuit which is configured with only a coil without the source capacitor Cs and the load capacitor C [symbol] for impedance matching, and if a maximum power transfer condition is obtained from the ratio, the maximum power transfer condition satisfies the following Equation (1).

Ls/Rs=L [symbol] /R [symbol] [Equation 1]

When a ratio of an inductance of the transfer coil Ls and a source resistance Rs is the same as a ratio of an inductance of the load coil L [symbol] and a load resistance R [symbol] according to Equation (1), maximum power transfer is possible. In a system where there is only an inductance, since there is no capacitor for compensating for reactance, a value of a reflection value S11 of an input/output port may not be 0 at a point at which maximum power transfer is performed, and power transfer efficiency may be largely changed based on a value of the mutual inductance Ms [symbol] . Therefore, the source capacitor Cs may be added to the wireless power transfer apparatus as a compensation capacitor for impedance matching, and the load capacitor C [symbol] may be added to the wireless power reception apparatus. The compensation capacitors Cs and C [symbol] may be connected to, for example, each of the reception coil Ls and the load coil L [symbol] in series or parallel. Also, in addition to the compensation capacitors, passive elements such as an additional capacitor and inductor may be added to each of the wireless power transfer apparatus and the wireless power reception apparatus for impedance matching.

FIG. 2 is a magnetic resonance equivalent circuit.

Referring to FIG. 2, in the magnetic resonance equivalent circuit, a wireless power transfer apparatus is implemented with a source coil, configuring a closed circuit based on a serial connection of a source voltage Vs, a source resistor Rs, and a source inductor Ls, and a transmitting-side resonant coil configuring a closed circuit based on a serial connection of a transmitting-side resonant inductor L1 and a transmitting-side resonant capacitor C1, and a wireless power reception apparatus is implemented with a load coil, configuring a closed circuit based on a serial connection of a load resistor L [symbol] and a load inductor L [symbol] , and a receiving-side resonant coil configuring a closed circuit based on a receiving-side resonant inductor L2 and a receiving-side resonant capacitor C2. The source inductor Ls and a transmitting-side inductor L1 are magnetically coupled as a coupling coefficient of K01, the load inductor L [symbol] and a load-side resonant inductor L1 are magnetically coupled as a coupling coefficient of K23, and a transmitting-side resonant inductor L1 and a receiving-side resonant inductor L2 are magnetically coupled as a coupling coefficient of L12. In an equivalent circuit according to another embodiment, a source coil and/or a load coil are omitted, and the equivalent circuit may be configured with only a transmitting-side resonant coil and a receiving-side resonant coil.

In the magnetic induction method, when resonance frequencies of two resonators are the same, most of energy of a resonator of the wireless power transmitting apparatus is transferred to a resonator of the wireless power reception apparatus, power transfer efficiency can be enhanced. Efficiency in the magnetic resonance method is enhanced when the following Equation (2) is satisfied.

k/Γ>>1 [Equation 2]

(k is a coupling coefficient, and Γ is an attenuation rate)

In the magnetic resonance method, in order to increase efficiency, an element for impedance matching may be added, and an impedance matching element may be a passive element such as an inductor or a capacitor.

Based on such wireless power transfer principle, a wireless power transfer system for transferring power in the magnetic induction method or the magnetic resonance method will be described.

<Wireless Power Transfer Apparatus>

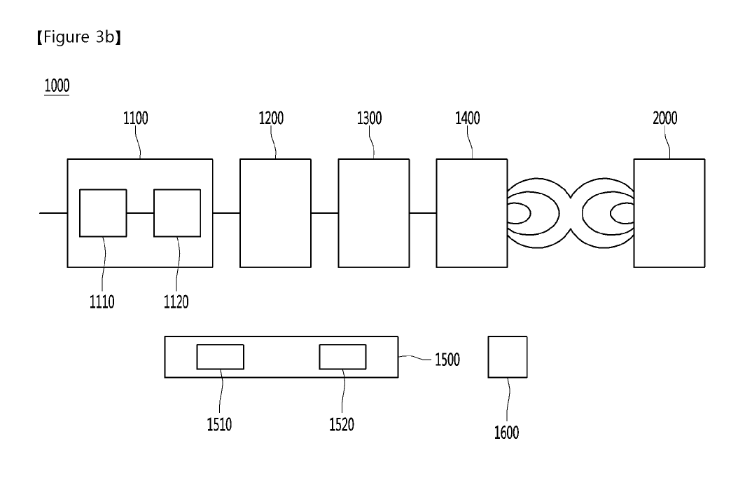

FIGS. 3A and 3B are block diagrams illustrating a wireless power transfer apparatus as one of subsystems configuring a wireless power transfer system.

Referring to FIG. 3A, the wireless power transfer system according to an embodiment may include a wireless power transfer apparatus 1000 and a wireless power reception apparatus 2000 which wirelessly receives power from the wireless power transfer apparatus 1000. The wireless power transfer apparatus 1000 may include a power converter 101 which power-converts an alternating current (AC) signal input thereto to output an AC signal, a resonant circuit unit 102 which generates a magnetic field, based on the AC signal output from the power converter 101 and provides power to the wireless power reception apparatus 2000 in a charging area, and a controller 103 which controls power conversion by the power converter 101, adjusts an amplitude and a frequency of an output signal of the power converter 101, performs impedance matching of the resonant circuit unit 102, sense impedance, voltage, and current information from the power converter 101 and the resonant circuit unit 102, and wirelessly communicates with the wireless power reception apparatus 2000. The power converter 101 may include one of a power conversion unit which converts an AC signal into a direct current (DC) signal, a power conversion unit which varies an AC level to output an AC signal, and a power conversion unit which converts a DC signal into an AC signal. Also, the resonant circuit unit 102 may include a coil and an impedance matching unit capable of resonating with the coil. Also, the controller 103 may include a sensing unit for sensing impedance, voltage, and current information and a wireless communicator.

Referring to FIG. 3 in detail, the wireless power transfer apparatus 1000 may include a transmitting-side AC/DC converter 1100, a transmitting-side DC/AC converter 1200, a transmitting-side impedance matching unit 1300, a transfer coil unit 1400, and a transmitting-side communication and control unit 1500.

The transmitting-side AC/DC converter 1100 is a power converter which converts an AC signal, provided from the outside, in a DC signal according to control by the the transmitting-side communication and control unit 1500, and the transmitting-side AC/DC converter 1100 may include a rectifier 1110 and a transmitting-side DC/AC converter 1120 as subsystems. The rectifier 1110 is a system which converts an AC signal, provided thereto, into a DC signal, and in an embodiment for implementing the rectifier 1110, the rectifier 1110 may be a diode rectifier having relatively high efficiency in a high frequency operation, a synchronous rectifier capable of one chip, or a hybrid rectifier which enables a space to be saved and is high in degree of freedom of a dead time. However, the rectifier 1110 is not limited thereto, and a system for converting an AC signal into a DC signal may be applied. Also, the transmitting-side DC/AC converter 1120 controls a level of a DC signal provided from the rectifier 1110 according to control by the transmitting-side communication and control unit 1500, and as an example that implements the transmitting-side DC/AC converter 1120, the transmitting-side DC/AC converter 1120 may be a buck converter which lowers a level of an input signal, a boost converter which increases a level of an input signal, or a buck boost converter or a cuk converter which lowers or increases a level of an input signal. Also, the transmitting-side DC/AC converter 1120 may include a switch element which performs a power conversion control function, an inductor and a capacitor which performs a function for power conversion or an output voltage smoothing function, and a transformer which adjusts a voltage gain or performs an electrical isolation function (an insulation function), and may remove a pulsating component (an AC component included in a DC signal) or a ripple component included in a DC signal input thereto. Also, a difference between a reference value of an output signal of the transmitting-side DC/AC converter 1120 and an actual output value may be controlled through a feedback manner, and the control may be performed by the transmitting-side communication and control unit 1500.

The transmitting-side DC/AC converter 1200 is a system which converts a DC signal, output from the transmitting-side AC/DC converter 1100, into an AC signal according to control by the transmitting-side communication and control unit 1500 and adjusts a frequency of the converted AC signal, and as an example that implements the transmitting-side DC/AC converter 1200, examples of the transmitting-side DC/AC converter 1200 include a half bridge inverter or a full bridge inverter. Also, various amplifiers for converting a DC signal into an AC signal may be applied to the wireless power transfer system, and for example, there is a class A amplifier, a class B amplifier, a class AB amplifier, a class C amplifier, a class E amplifier, and a class F amplifier. Also, the transmitting-side DC/AC converter 1200 may include an oscillator which generates a frequency of an output signal and a power amplifier which amplifies the output signal.

The transmitting-side impedance matching unit 1300 minimizes a reflective wave at a point having different impedances to improve a flow of a signal. Two coils of the wireless power transfer apparatus 1000 and the wireless power reception apparatus 2000 are spatially separated from each other, and for this reason, leakage of a magnetic field is large. Therefore, power transfer efficiency can be enhanced by correcting an impedance difference between two connection ports of the wireless power transfer apparatus 1000 and the wireless power reception apparatus 2000. The transmitting-side impedance matching unit 1300 may be configured with an inductor, a capacitor, and a resistor and may vary an inductance of the inductor, a capacitance of the capacitor, and a resistance value of the resistor according to control by the communication and control unit 1500 to adjust an impedance value for impedance matching. Also, in a case where the wireless power transfer system transfers power in the magnetic induction method, the transmitting-side impedance matching unit 1300 may have a serial resonance structure or a parallel resonance structure and may increase an induction coupling coefficient between the wireless power transfer apparatus 1000 and the wireless power reception apparatus 2000 to minimize the loss of energy. Also, in a case where the wireless power transfer system transfers power in the magnetic resonance method, the transmitting-side impedance matching unit 1300 may enable impedance matching to be corrected in real time based on a variation of matching impedance on an energy transfer line caused by a variation of a separation distance between the wireless power transfer apparatus 1000 and the wireless power reception apparatus 2000 and a change in characteristic of a coil caused by influences of a foreign object (FO) and a plurality of devices, and examples of a correction method may include a multi-matching method using a capacitor, a matching method using a multi-antenna, and a method using a multi-loop.

The transmitting-side coil 1400 may be implemented with a plurality of coils or a single coil. In a case where the transmitting-side coil 1400 is provided in plurality, the plurality of transmitting-side coils 1400 may be spaced apart from each other or may be disposed to overlap each other, and the transmitting-side coils 1440 are disposed to overlap each other, an overlapping area may be determined based on a deviation of a magnetic flux density. Also, in a process where the transmitting-side coil 1400 is manufactured, the transmitting-side coil 1400 may be manufactured based on an internal resistance and a radiation resistance, and in this case, if a resistance component is small, a QA can increase, and transfer efficiency can increase.

The communication and control unit 1500 may include a transmitting-side controller 1510 and a transmitting-side communicator 1520. The transmitting-side controller 1510 may control an output voltage of the transmitting-side AC/DC converter 1100, based on a required power amount of the wireless power reception apparatus 2000, a currently charged amount, and a wireless power manner. Also, power may be controlled by generating a frequency and switching waveforms for driving the transmitting-side DC/AC converter 1200, based on maximum power transfer efficiency. Also, the transmitting-side controller 1510 may determine a size of the wireless power reception apparatus, based on unique information RXID received from the wireless power reception apparatus. That is, one of a plurality of transfer coils may be selected based on a size of the wireless power reception apparatus. The unique information RXID may include an RXID message, certification information, identification information, and an error detection code CRC, but is not limited thereto. The RXID message may include information about a power amount of the wireless power reception apparatus.

Moreover, an overall operation of the wireless power reception apparatus 2000 may be controlled by using an algorithm, a program, or an application which is read from a storage unit (not shown) of the wireless power reception apparatus 2000 and is needed for control. The transmitting-side controller 1510 may be referred to as a microprocessor, a micro controller unit, or a microcomputer. The transmitting-side communicator 1520 may perform communication with the receiving-side communicator 2620, and for example, a communication scheme may use a short range communication scheme such as Bluetooth, near field communication (NFC), or Zigbee. The transmitting-side communicator 1520 and the receiving-side communicator 2620 may transmit or receive charging situation information and a charging control command therebetween. Also, the charging situation information may include the number of the wireless power reception apparatuses 2000, the balance of a battery, the number of charging, an used amount, a battery capacity, a battery rate, and a transfer power amount of the wireless power transfer apparatus 1000. Also, the transmitting-side communicator 1520 may transfer a charging function control signal for controlling a charging function of the wireless power reception apparatus 2000, and the charging function control signal may be a control signal which controls the wireless power reception apparatus 2000 to enable or disable the charging function.

In this manner, the transmitting-side communicator 1520 may perform communication in an out-of-band manner configured with a separate module, but is not limited thereto. The transmitting-side communicator 1520 may perform communication in an in-band manner using a feedback signal which is transferred from the wireless power reception apparatus to the wireless power transfer apparatus by using a power signal transferred from the wireless power transfer apparatus. For example, the wireless power reception apparatus may modulate the feedback signal and may transfer, to a transmitter, information such as charging start, charging end, a battery state by using the feedback signal. Also, the transmitting-side communicator 1520 may be configured separately from the transmitting-side controller 1510, and in the wireless power reception apparatus 2000, the receiving-side communicator 2620 may be included in the controller 2610 of the reception apparatus or may be separately configured.

<Wireless Power Reception Apparatus>

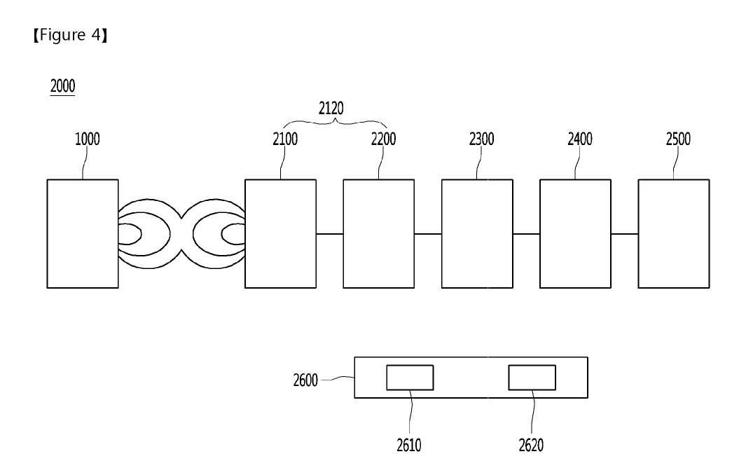

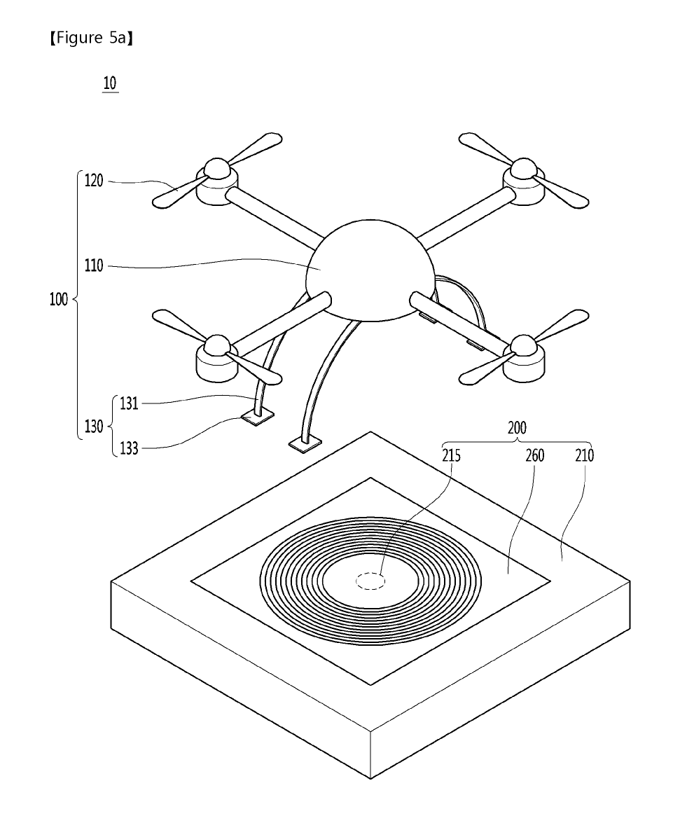

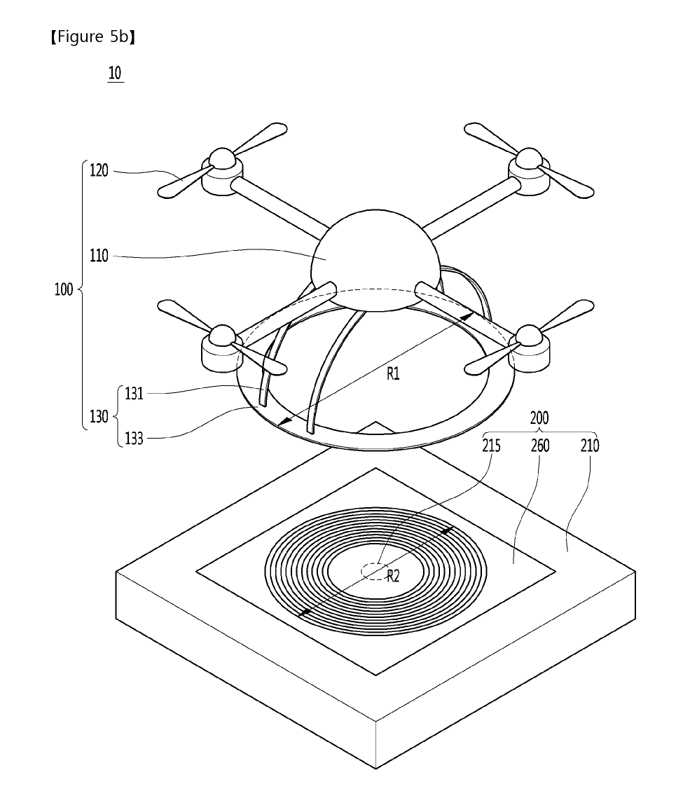

FIG. 4 is a block diagram illustrating a wireless power reception apparatus as one of subsystems configuring a wireless power transfer system.

Referring to FIG. 4, the wireless power transfer system may include a wireless power transfer apparatus 1000 and a wireless power reception apparatus 2000 which wirelessly receives power from the wireless power transfer apparatus 1000. The wireless power reception apparatus 2000 may include a receiving-side coil unit 2100, a receiving-side impedance matching unit 2200, a receiving-side AC/DC converter 2300, a receiving-side DC/AC converter 2400, a load 2500, and a receiving-side communication and control unit 2600.

The receiving-side coil unit 2100 may receive power through the magnetic induction method or the magnetic resonance method. In this manner, the receiving-side coil unit 2100 may include one or more of an induction coil or a resonant coil, based on a power reception method. Also, the receiving-side coil unit 2100 may include an NFC antenna. Also, the receiving-side coil unit 2100 may be the same as the transmitting-side coil unit 1400, and a dimension of a reception antenna may be changed based on an electrical characteristic of the wireless power reception apparatus 2000.

The receiving-side impedance matching unit 2200 performs impedance matching between the wireless power transfer apparatus 1000 and the wireless power reception apparatus 2000.

The receiving-side AC/DC converter 2300 may rectify an AC signal output from the receiving-side coil unit 2100 to generate a DC signal.

The receiving-side DC/AC converter 2400 may adjust a level of the DC signal output from the receiving-side AC/DC converter 2300 according to a capacity of the load 2500.

The load 2500 may include a battery, a display, a sound output circuit, a main processor, and various sensors.

The receiving-side communication and control unit 2600 may be activated by a wake-up power from the transmitting-side communication and control unit 1500, may perform communication with the transmitting-side communication and control unit 1500, and may control an operation of a subsystem of the wireless power reception apparatus 2000.

The wireless power reception apparatus 2000 may be as one or in plurality and may simultaneously receive energy from the wireless power transfer apparatus 1000. That is, in a wireless power transfer system based on the magnetic resonance method, a plurality of target wireless power reception apparatuses 2000 may be provided with power from one the wireless power transfer apparatus 1000. At this time, the transmitting-side matching unit 1300 of the wireless power transfer apparatus 1000 may adaptively perform impedance matching between a plurality of the wireless power reception apparatuses 2000. This may be identically applied to a case where independent receiving-side coil unit is provided in plurality in the magnetic induction method.

Moreover, in a case where the wireless power reception apparatus 2000 is provided in plurality, the plurality of wireless power reception apparatuses 2000 may be systems using the same power reception method or different kinds of systems. In this case, the wireless power transfer apparatus 1000 may be a system which transfers power in the magnetic induction method or the magnetic resonance method or may be a system using both the magnetic induction method and the magnetic resonance method.

To describe a relationship between a frequency and a level of a signal of the wireless power transfer system, in wireless power transfer based on the magnetic induction method, the transmitting-side AC/DC converter 1100 in the wireless power transfer apparatus 1000 may receive an AC signal of tens or hundreds Hz (for example, 60 Hz) of tens or hundreds V (for example, 100V to 220V), convert the AC signal into a DC signal, output the DC signal, and the transmitting-side DC/AC converter 1200 may receive the DC signal to output an AC signal of KHz (for example, 125 KHz). Also, the receiving-side AC/DC converter 2300 in the wireless power reception apparatus 2000 may receive the AC signal of KHz (for example, 125 KHz), convert the AC signal into a DC signal of several V to tens V or hundreds V (for example, 10V to 20V), and output the DC signal, and the receiving-side DC/AC converter 2400 may output, for example, a DC signal of 5V suitable for the load 2500 and may transfer the DC signal to the load 2500. Also, in wireless power transfer based on the magnetic resonance method, the transmitting-side AC/DC converter 1100 in the wireless power transfer apparatus 1000 may receive an AC signal of tens or hundreds Hz (for example, 60 Hz) of tens or hundreds V (for example, 100V to 220V), convert the AC signal into a DC signal, output the DC signal, and the transmitting-side DC/AC converter 1200 may receive the DC signal to output an AC signal of MHz (for example, 6.78 MHz). Also, the receiving-side AC/DC converter 2300 in the wireless power reception apparatus 2000 may receive the AC signal of MHz (for example, 6.78 MHz), convert the AC signal into a receiving-side DC signal of several V to tens V or hundreds V (for example, 10V to 20V), and output the receiving-side DC signal, and the DC/AC converter 2400 may output, for example, a DC signal of 5V suitable for the load 2500 and may transfer the DC signal to the load 2500.

FIG. 5A is a diagram describing a wireless charging system for unmanned aerial vehicles according to an embodiment. Referring to FIG. 5A, a wireless charging system 10 for unmanned aerial vehicles includes an unmanned aerial vehicle 100 and a charging apparatus 200.

An unmanned aerial vehicle denotes an aerial vehicle which is remotely controlled even when a person does not board and control the aerial vehicle, or operates according to a pre-stored program. As a detailed example, the unmanned aerial vehicle is a concept including all of a tri-rotor including three propellers, a quad-rotor including four propellers, a penta-rotor including five propellers, a hexa-rotor including six propellers, and an octa-rotor including eight propellers. Hereinafter, therefore, for convenience of description, the quad-rotor will be described for example, but the scope of the present invention is not limited thereto. Various types of unmanned aerial vehicles may be implemented based on the number and configuration of propellers.

The unmanned aerial vehicle 100 according to an embodiment includes a body part equipped with a module for controlling the supply of power and a flying operation, a wing part 120 including a four-direction frame and propeller with respect to the body part 110, and a leg part 130 disposed under the body part 110.

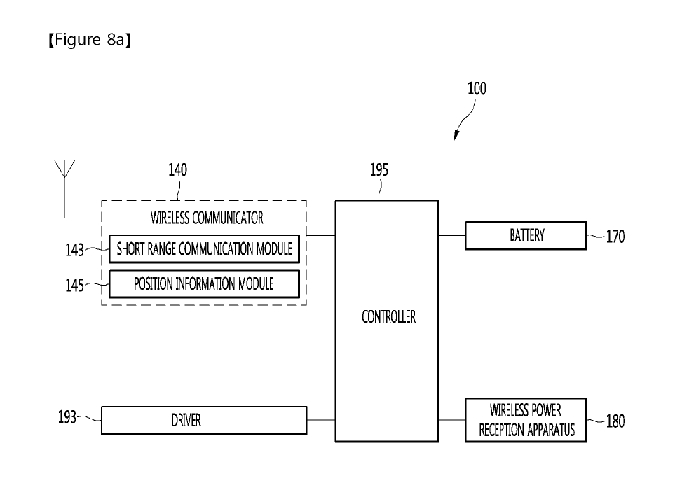

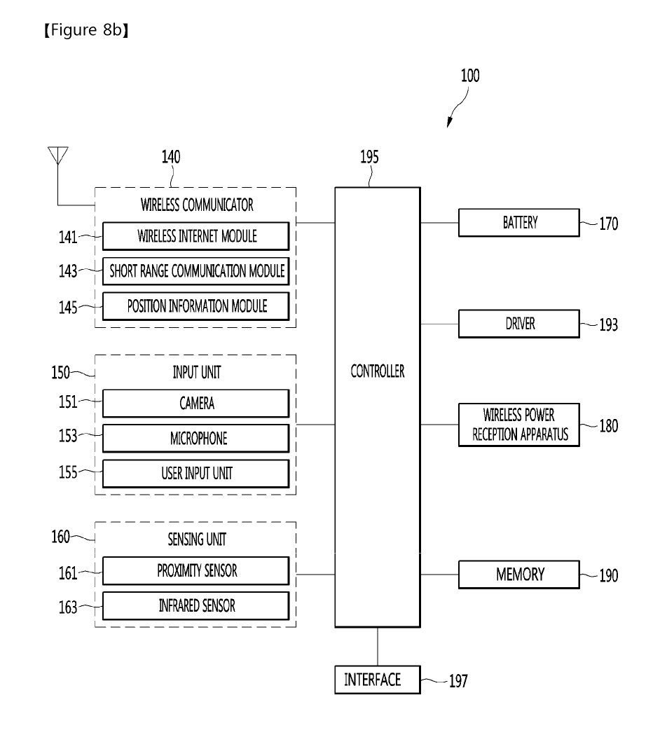

The body part 110 may include a controller 195 which controls a flying operation of the unmanned aerial vehicle 100 to be described below with reference to FIG. 8A and a wireless communicator 140 for exchanging data with a remote controller, a server, or a charging apparatus.

The body part 110 may have a shape which is changed based on the kind of an unmanned aerial vehicle. For example, in the tri-rotor, the body part 110 may be configured as an equilateral triangle plate, and in the quad-rotor, the body part 110 may be configured as a square plate. The present invention is no limited thereto.

The wing part 120 may include a driver which converts electrical energy into mechanical energy to rotate a propeller and the propeller which is rotated by the driver.

The leg part 130 may be disposed under the unmanned aerial vehicle 110, and when the unmanned aerial vehicle lands on the ground, the leg part 130 may maintain a stable posture and may reduce a landing impact. The leg part 130 may use Styrofoam, memory foam, or hardening sponge, but is not limited thereto.

The leg part 130 may be configured with a support part 131 supporting the body part 110 and a landing part 133 connected to a lower end of the support part 131.

Particularly, in the unmanned aerial vehicle 100 according to an embodiment, a wireless power reception apparatus 180 (2000 of FIG. 4) may be equipped in the landing part 133 and may receive a wireless charging power from the charging apparatus 200. Also, in the unmanned aerial vehicle 100, the wireless power reception apparatus 180 (2000 of FIG. 4) may be equipped in a lower end of the landing part 133 and may receive the power from the charging apparatus 200. Also, the wireless power reception apparatus 180 (2000 of FIG. 4) may be equipped in a lower end of the body part 110 or a lower end of a camera equipped in the lower end of the body part 110 and may receive the power from the charging apparatus 200.

The charging apparatus 200 includes a wireless power transfer apparatus 260 (1000 of FIGS. 3A and 3B) including a transfer coil and a support member 210. The transfer coil may be a single coil or an array where a plurality of coils are disposed, and a diameter of the transfer coil may be greater than an interval between a plurality of the leg parts 130.

Moreover, referring to FIG. 5B, a reception coil of the wireless power reception apparatus may have a size which is the same as that of the transfer coil. The leg part 130 of the unmanned aerial vehicle 100 may be configured with the support part 131 supporting the body part 110 and the landing part 133 connected to the lower end of the support part 131, and the landing part 133 may be equipped with the reception coil having the same shape and size as those of the transfer coil and may receive the power from the charging apparatus 200. For example, a diameter R1 of the reception coil of the wireless power reception apparatus may be the same as a diameter R2 of the transfer coil. The reception coil having the same shape and size may act as a landing part by adjusting the balance of the unmanned aerial vehicle. According to an embodiment, a shape of each of the reception coil and the transfer coil may be polygonal or elliptical.

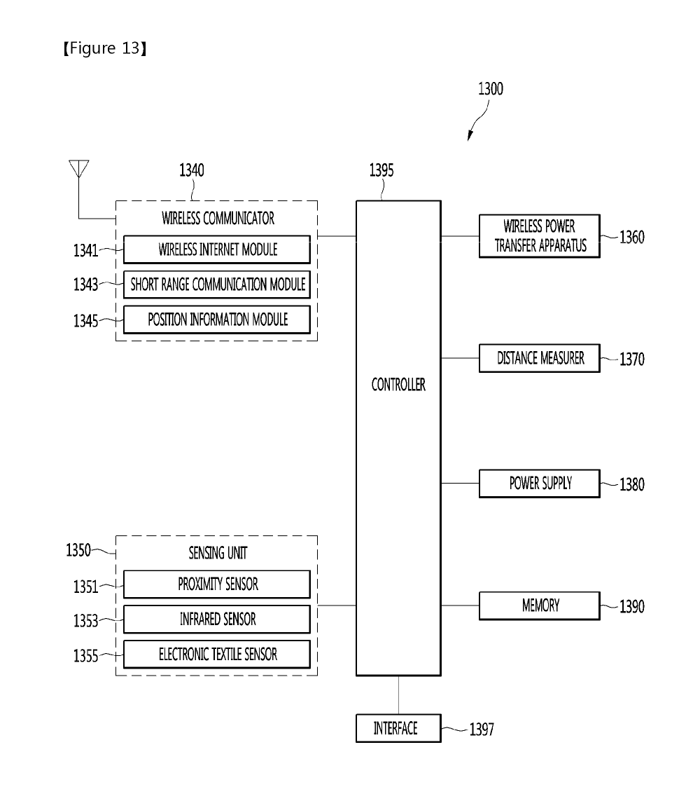

In the wireless power transfer apparatus 260, a hall sensor 215 may be disposed inside the transfer coil and may sense a magnetic substance disposed inside the reception coil of the wireless power reception apparatus 180 to determine whether the unmanned aerial vehicle 100 lands and aligns. The hall sensor 215 may sense an intensity of a magnetic flux density of the magnetic substance, and if the intensity of the magnetic flux density of the magnetic substance is equal to or greater than a threshold value, a controller (295 of FIG. 13A) of the charging apparatus 200 may determine that the landing and alignment are completed for charging the unmanned aerial vehicle, and may perform control to start charging. That is, in the wireless charging system for unmanned aerial vehicles according to an embodiment, the unmanned aerial vehicle 100 may land on the charging apparatus 200, and the wireless power reception apparatus equipped in the unmanned aerial vehicle 100 and the wireless power transfer apparatus equipped in the charging apparatus 200 may transfer and receive a wireless power to charge the unmanned aerial vehicle 100.

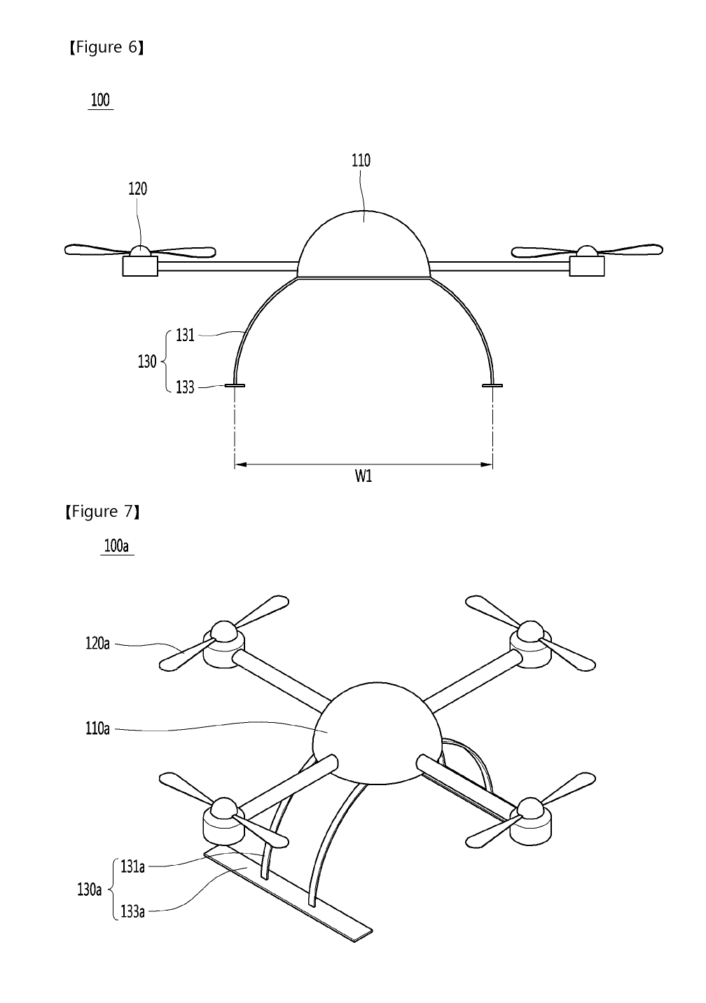

FIG. 6 is a front view of an unmanned aerial vehicle according to an embodiment. Referring to FIG. 6, an unmanned aerial vehicle 100 is configured with a body part equipped with a module for controlling the supply of power and a flying operation, a wing part 120 including a four-direction frame and propeller with respect to the body part 110, and a leg part 130 which is disposed under the body part 110 and includes a support part 131 and a landing part 133. An interval W1 between a plurality of the leg parts 130 may be 15 cm or less, but is not limited thereto.

FIG. 7 is a perspective view of an unmanned aerial vehicle according to another embodiment.

Referring to FIG. 7, in comparison with the embodiment of FIG. 5, another embodiment is the same as the embodiment of FIG. 5, except that a shape of the leg part 130 is modified. In describing another embodiment, detailed descriptions of elements which are the same as or similar to those of the embodiment of FIG. 5 are omitted. A leg part 130a may be configured with a support part 131a, which supports a body part 110a, and a landing part 133a connected to an end of the support part 131a. In an embodiment, an unmanned aerial vehicle 100a may be configured with two the landing parts 133a, and a wireless power reception apparatus 180 may be equipped in a lower end of the landing part 133a and may receive power from a charging apparatus 200.

Moreover, according to an embodiment, a reception coil of the wireless power reception apparatus 180 and a transfer coil of a wireless power transfer apparatus 280 disposed in the charging apparatus 200 may be disposed in plurality so as to match each other in a one-to-one (1:1) relationship, and the reception coil and the transfer coil may be disposed to have the same shape and size, thereby enhancing wireless charging efficiency.

According to an embodiment, a shape of each of the reception coil and the transfer coil may be polygonal or elliptical.

FIG. 8A is a system block diagram of an unmanned aerial vehicle according to an embodiment.

Referring to FIG. 8A, an unmanned aerial vehicle 100 includes a wireless communicator 140, a battery 170, a wireless power reception apparatus 180, a memory 190, a driver 193, and a controller 195.

The wireless communicator 140 may include one or more modules which enable wireless communication between the unmanned aerial vehicle 100 and a wireless communication system (not shown), between the unmanned aerial vehicle 100 and another unmanned aerial vehicle, or between the unmanned aerial vehicle 100 and a cloud server (not shown). Also, the wireless communicator 140 may include one or more modules which connect the unmanned aerial vehicle 100 to one or more networks.

The wireless communicator 140 may include at least one of a short range communication module 143 and a position information module 145. The short range communication module 143 is for short range communication and may support short range communication by using at least one of Bluetooth™, a radio frequency identification (RFID), infrared data association (IrDA), ultra wideband (UWB), ZigBee, NFC, wireless-fidelity (Wi-Fi), Wi-Fi direct, and wireless universal serial bus (USB). The short range communication module 143 may support wireless communication between the unmanned aerial vehicle 100 and the wireless communication system and between the unmanned aerial vehicle 100 and another unmanned aerial vehicle over a wireless area network. The wireless area network may be a wireless personal area network.

The position information module 145 is a module for obtaining a position of the unmanned aerial vehicle 100, and as a representative example, there is a global positioning system (GPS) module or a Wi-Fi module. For example, if the GPS module is used, the unmanned aerial vehicle 100 may obtain a position of the unmanned aerial vehicle 100 by using a signal transmitted from a GPS satellite. As another example, if the Wi-Fi module is used, the unmanned aerial vehicle 100 may obtain a position of the unmanned aerial vehicle 100, based on information about a wireless access point (AP) which transmits or receives a wireless signal to or from the Wi-Fi module. The position information module 145 is a module used to obtain the position of the unmanned aerial vehicle 100 and is not limited to a module which directly calculates or obtains the position of the unmanned aerial vehicle 100.

The battery 170 receives an external power or an internal power to supply power to each of elements included in the unmanned aerial vehicle 100 according to control by the controller 195. The battery 170 may be an embedded battery or a replaceable battery.

The wireless power reception apparatus 180 may be configured identically to the wireless power reception apparatus 2000 described above with reference to FIGS. 1 to 4.

The memory 190 stores data which supports various functions of the unmanned aerial vehicle 100. The memory 190 may store a plurality of application programs or applications driven by the unmanned aerial vehicle 100 and pieces of data and commands for an operation of the unmanned aerial vehicle 100. At least some of the application programs may be downloaded from an external server through wireless communication. The application programs may be stored in the memory 190, installed in the unmanned aerial vehicle 100, and driven to perform an operation (or a function) of the unmanned aerial vehicle 100 according to control by the controller 195.

The driver 193 may include one or more power apparatuses which enable the unmanned aerial vehicle 100 to fly. For example, the driver 193 may include at least one of a motor and an engine.

The controller 195 may process a signal, data, information, and the like input or output through the above-described elements or may drive the application program stored in the memory 190, thereby providing or processing a function or information appropriate for a user.

Moreover, the controller 195 may control at least some of the elements described above with reference to FIG. 8, for driving the application program stored in the memory 190. Furthermore, in order to drive the application program, the controller 195 may combine and operate two or more of the elements included in the unmanned aerial vehicle 100.

At least some of the elements may cooperate for implementing an operation, control, or a control method of the unmanned aerial vehicle 100 according to various embodiments to be described below. Also, the operation, control, or control method of the unmanned aerial vehicle 100 may be implemented in the unmanned aerial vehicle 100 by driving at least one application program stored in the memory 190.

FIG. 8B is a system block diagram of an unmanned aerial vehicle according to another embodiment. Referring to FIG. 8B, an unmanned aerial vehicle 100 includes a wireless communicator 140, an input unit 150, a sensing unit 160, a battery 170, a wireless power reception apparatus 180, a memory 190, a driver 193, a controller 195, and an interface 197. In describing another embodiment, detailed descriptions of elements which are the same as or similar to those of the embodiment of FIG. 8A are omitted. Elements illustrated in FIG. 8B are not essential in implementing the unmanned aerial vehicle 100, and thus, the unmanned aerial vehicle 100 described herein may include more or fewer elements than the above-described elements.

The wireless communicator 140 may include at least one of a wireless Internet module 141, a short range communication module 143, and a position information module 145. The wireless Internet module 141 may perform wireless Internet access and may be embedded into or provided outside the unmanned aerial vehicle 100. The wireless Internet module 141 is configured to transmit or receive a wireless signal over a communication network based wireless Internet technologies.

Examples of the wireless Internet technologies may include wireless local area network (WLAN), Wi-Fi, Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), etc., and the wireless Internet technology 141 transmits or receives data according to at least one of wireless Internet technologies including Internet technology which is not described above.

The input unit 150 may include a camera 151 or an image input unit for inputting an image signal, a microphone 153 or an audio input unit for inputting an audio signal, and a user input unit 155 (for example, a touch key, a mechanical key, etc.) for receiving information from a user. Sound data or image data collected by the input unit 150 may be analyzed and may be processed as a control command of a user.

The input unit 150 is for inputting image information (or a signal), audio information (or a signal), data, or information input from a user and the unmanned aerial vehicle 100 may include one or a plurality of cameras 151, for inputting the image information.

The camera 151 processes an image frame such as a still image or a moving image obtained by an image sensor in a video call mode or a photographing mode. The processed image frame may be stored in the memory 190, transmitted to a protector or a public institution, or transmitted to or stored in a cloud server.

The microphone 153 processes an external sound signal into electrical sound data. The user input unit 153 is for receiving information from a user, and when information is input through the user input unit 153, the controller 195 may control an operation of the unmanned aerial vehicle 100, based on the input information. The user input unit 153 may include a mechanical input means (or a mechanical key, for example, a dome switch, a jog wheel, a jog switch, and a button disposed on a front surface, a rear surface, or a side surface of the unmanned aerial vehicle 100) and a touch type input means. For example, the touch type input means may be configured with a virtual key, a soft key, or a visual key, which is displayed on a touch screen through software processing, or may be configured with a touch key disposed in a portion other than the touch screen.

The sensing unit 160 may include one or more sensors for sensing at least one of internal information about the unmanned aerial vehicle 100, ambient environment information about the unmanned aerial vehicle 100, and user information. For example, the sensing unit 160 may include at least one of a proximity sensor 161, an illumination sensor, a touch sensor, an acceleration sensor, a magnetic sensor, a G-sensor, a gyroscope sensor, a motion sensor, an RGB sensor, an infrared sensor 142, a finger scan sensor, an ultrasonic sensor, an optical sensor (for example, a camera (see 151)), a microphone (see 153), a battery gauge, an environment sensor (for example, a barometer, a hygrometer, a thermometer, a radiation sensing sensor, a heat sensing sensor, a gas sensing sensor, etc.), and a chemical sensor (for example, an e-nose, a healthcare sensor, a biometric sensor, etc.). The unmanned aerial vehicle 100 disclosed herein may combine and use pieces of information sensed by two or more of the sensors.

The proximity sensor 161 denotes a sensor which detects an object approaching a certain detection surface or the presence of a nearby object by using a force of an electromagnetic field or infrared light without a mechanical contact. The proximity sensor 161 may sense an object in front of or behind the unmanned aerial vehicle 100, and thus, the unmanned aerial vehicle 100 may fly while avoiding the object or may determine the kind of the object.

The infrared sensor 163 is a sensor which detects a distance to a front object, and may enable the unmanned aerial vehicle 100 to fly at an altitude in a front/rear/left/right direction while maintaining a constant distance to a user.

In the present invention, in addition to the above-described sensors, more sensors may be added, or some of the above-described sensors may be omitted. However, the present invention is not limited thereto.

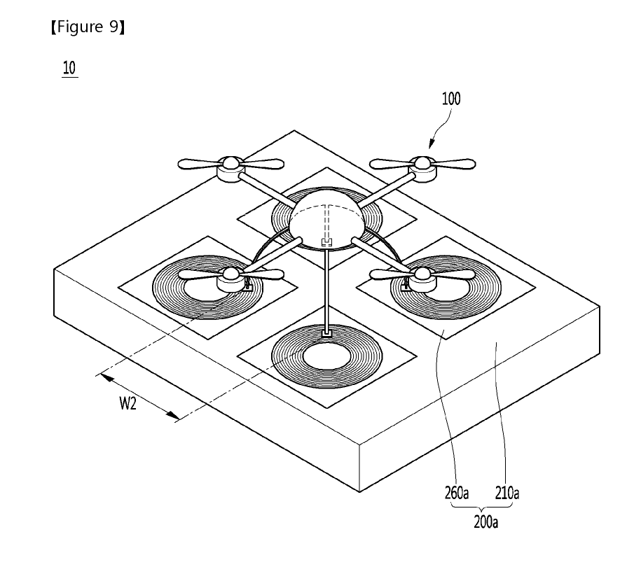

FIG. 9 is a diagram describing a wireless charging system for unmanned aerial vehicles according to another embodiment. Referring to FIG. 9, except that a configuration of a charging apparatus is modified in comparison with the embodiment of the FIG. 5, a wireless charging system 10 for unmanned aerial vehicles according to another embodiment is the same as the embodiment of the FIG. 5. In describing another embodiment, therefore, detailed descriptions of elements which are the same as or similar to those of the embodiment of FIG. 5 are omitted.

A charging apparatus 200a includes a wireless power transfer apparatus 260a including a transfer coil and a support member 210a. The charging apparatus 200a may include a plurality of wireless power transfer apparatuses 260a, and for example, four the wireless power transfer apparatuses 260a may be disposed. In this case, a reception coil of a wireless power reception apparatus and the transfer coil of the wireless power transfer apparatus 260a may be disposed to have the same shape and size, thereby enhancing wireless charging efficiency.

In the unmanned aerial vehicle 100, a plurality of the wireless power transfer apparatuses 260a may be respectively disposed in a plurality of landing parts. An interval W2 between the plurality of landing parts of the unmanned aerial vehicle 100 may be equal to or greater than an interval between the plurality of wireless power transfer apparatuses 260a, and for example, the interval W2 between the plurality of landing parts of the unmanned aerial vehicle 100 may be 15 cm or less, but is not limited thereto. That is, the wireless power reception apparatuses respectively disposed in the landing parts of the unmanned aerial vehicle 100 receive a wireless power from the plurality of wireless power transfer apparatuses having a parallel structure, thereby enhancing wireless charging efficiency.

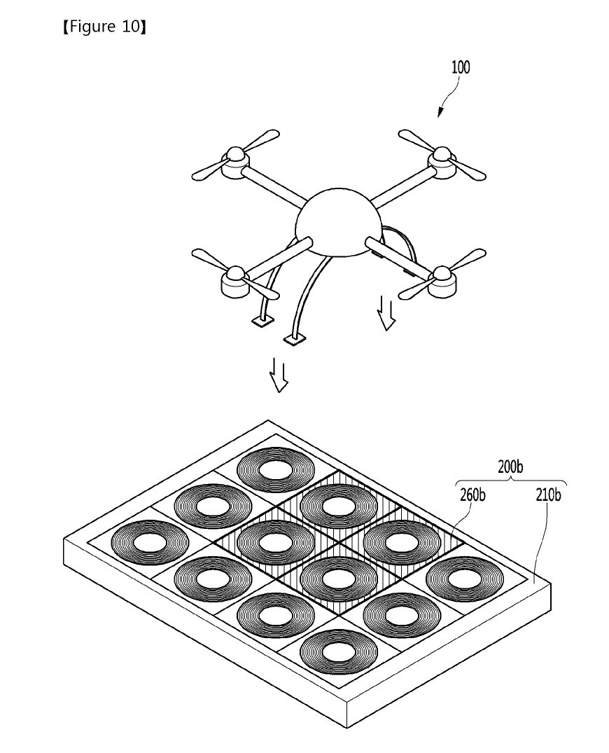

FIG. 10 is a diagram describing a wireless charging system for unmanned aerial vehicles according to another embodiment. Referring to FIG. 10, except that a configuration of a charging apparatus is modified in comparison with the embodiment of the FIG. 5, a wireless charging system 10 for unmanned aerial vehicles according to another embodiment is the same as the embodiment of the FIG. 5. In describing another embodiment, therefore, detailed descriptions of elements which are the same as or similar to those of the embodiment of FIG. 5 are omitted.

A charging apparatus 200b includes a wireless power transfer apparatus 260b including a transfer coil and a support member 210b. The charging apparatus 200b may include a plurality of wireless power transfer apparatuses 260a having a matrix type on the support member 210b.

In an embodiment, the unmanned aerial vehicle 100 may receive, through a position information module 145, GPS information about a place at which the charging apparatus 200 is installed, and may land on the charging apparatus 200, based on the GPS information. The charging apparatus 200 may select one or more wireless power transfer apparatuses corresponding to a landing point of the unmanned aerial vehicle 100 and may perform wireless charging by using the selected wireless power transfer apparatus (an obliquely-striped portion).

That is, the wireless charging system for unmanned aerial vehicles according to another embodiment drives only a wireless power transfer apparatus partially coupled to a wireless power reception apparatus of the unmanned aerial vehicle 100, thereby enhancing wireless charging efficiency.

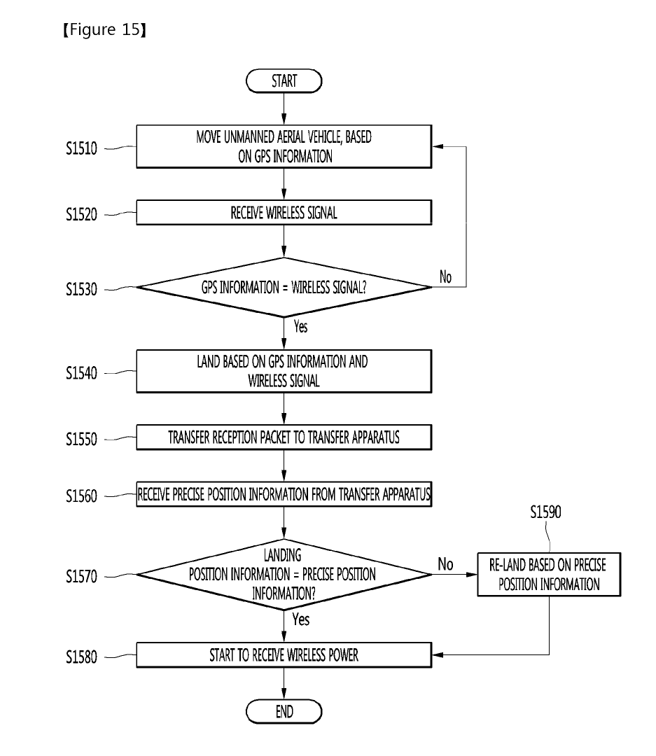

In a case where the transfer coil of the charging apparatus 200 and a reception coil of the unmanned aerial vehicle 100 match each other in a one-to-one (1:1) relationship, a method (see FIG. 15) of guiding, by the charging apparatus 200, landing of the unmanned aerial vehicle 100 will be described below.

The unmanned aerial vehicle 100 may move to approach the charging apparatus 200, based on the GPS information. At this time, the charging apparatus 200 may transfer a wireless signal to the unmanned aerial vehicle 100. The wireless signal may include AP information about an AP where the charging apparatus 200 is located. The unmanned aerial vehicle 100 may determine a landing point, based on the GPS information and the AP information included in the received wireless signal and may land.

When the unmanned aerial vehicle 100 has landed, the charging apparatus 200 may transfer a digital signal.

The digital signal may include a power beacon, and the power beacon may provide a sufficient power which enables the wireless power reception apparatus to start and respond. In an embodiment, the charging apparatus 200 may transmit the digital signal five times or less for a time of 28 ms or less, and if there is no response of the wireless power reception apparatus, the charging apparatus 200 may return to a standby state.

The wireless power reception apparatus of the unmanned aerial vehicle 100 may transfer a reception packet to the charging apparatus 200. The reception packet may include reception power information, and the charging apparatus 200 may determine whether to align the unmanned aerial vehicle 100, based on the reception power information. For example, if the reception power information included in the reception packet is equal to or greater than a threshold value, a controller 295 of the charging apparatus 200 may determine that the alignment of the unmanned aerial vehicle 100 is completed, and may start charging. Also, if the reception power information is greater than the threshold value, the controller 295 of the charging apparatus 200 may perform control to turn off a driver.

If the reception power information included in the reception packet is equal to or less than the threshold value, the controller 295 of the charging apparatus 200 may determine that the alignment of the unmanned aerial vehicle 100 fails, generate precise position information based on the reception power information included in the reception packet, and transfer the precise position information to the unmanned aerial vehicle 100. In this case, the precise position information may include precise position coordinates of the transfer coil, based on the reception power information included in the reception packet.

In a case where the transfer coil of the charging apparatus 200 and a reception coil of the unmanned aerial vehicle 100 match each other in a one-to-one (1:1) relationship, a method of guiding, by the charging apparatus 200, landing of the unmanned aerial vehicle 100 by using a hall sensor will be described below.

The unmanned aerial vehicle 100 may move to approach the charging apparatus 200, based on the GPS information. At this time, the charging apparatus 200 may transfer a wireless signal to the unmanned aerial vehicle 100. The wireless signal may include AP information about an AP where the charging apparatus 200 is located. The unmanned aerial vehicle 100 may determine a landing point, based on the GPS information and the AP information included in the received wireless signal and may land.

When the unmanned aerial vehicle 100 has landed, the charging apparatus 200 may transfer a digital signal. The digital signal may include a power beacon, and the power beacon may provide a sufficient power which enables the wireless power reception apparatus to start and respond. In an embodiment, the charging apparatus 200 may transmit the digital signal five times or less for a time of 28 ms or less, and if there is no response of the wireless power reception apparatus, the charging apparatus 200 may return to a standby state.

In the wireless power transfer apparatus 260 of the charging apparatus 200, a hall sensor 215 may be disposed inside the transfer coil and may sense a magnetic substance disposed inside the reception coil of the wireless power reception apparatus 180 to determine whether the unmanned aerial vehicle 100 lands and aligns. The hall sensor 215 may sense an intensity of a magnetic flux density of the magnetic substance, and if the intensity of the magnetic flux density of the magnetic substance is equal to or greater than a predetermined threshold value, the controller 295 of the charging apparatus 200 may determine that the landing and alignment are completed for charging the unmanned aerial vehicle, and may perform control to start charging. If the intensity of the magnetic flux density of the magnetic substance is equal to or less than the threshold value, the controller 295 of the charging apparatus 200 may transfer precise position information to the unmanned aerial vehicle 100 to induce re-landing.

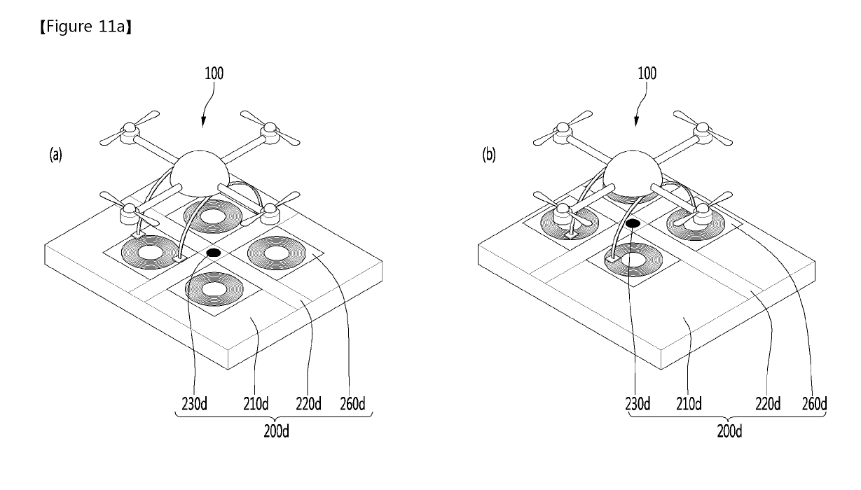

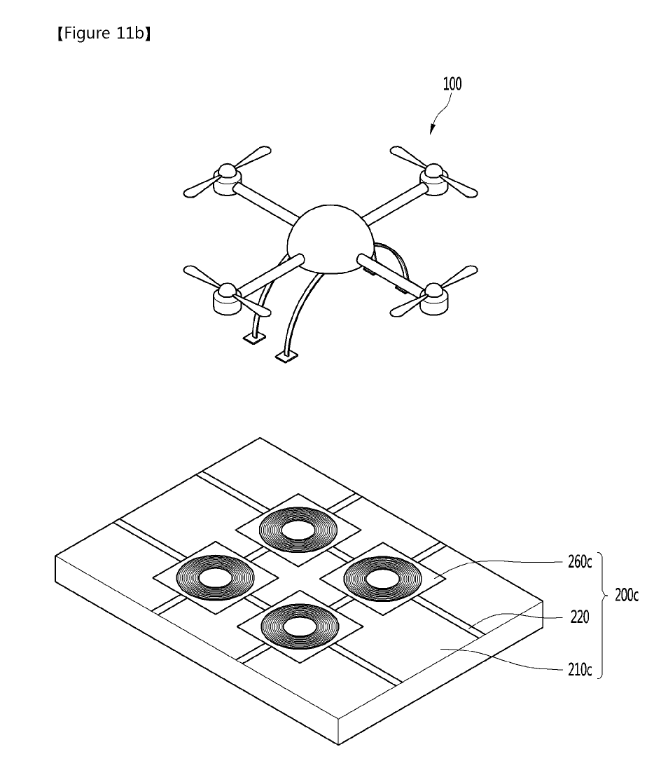

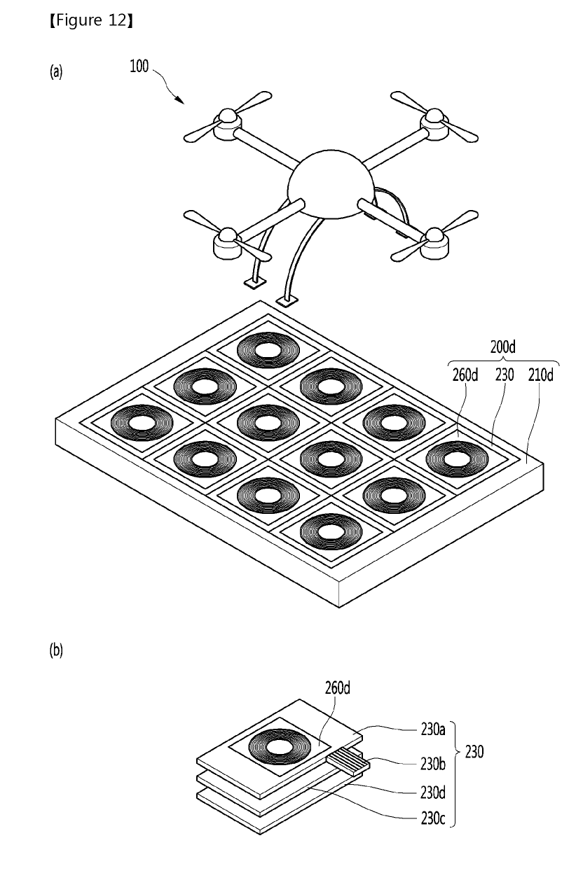

FIG. 11A is a diagram describing a wireless charging system for unmanned aerial vehicles according to another embodiment. Referring to FIG. 11A, except that a configuration of a charging apparatus is modified in comparison with the embodiment of the FIG. 5, a wireless charging system 10 for unmanned aerial vehicles according to another embodiment is the same as the embodiment of the FIG. 5. In describing another embodiment, therefore, detailed descriptions of elements which are the same as or similar to those of the embodiment of FIG. 5 are omitted.

A charging apparatus 200d includes a wireless power transfer apparatus 260d including a transfer coil, a support member 210d, a moving member 220d, and a driving motor 230d. In the charging apparatus 200d, four paired wireless power transfer apparatuses 260a may be disposed on the support member 210d.

The moving member 220d is connected to each of a plurality of the wireless power transfer apparatuses 260d and connects the plurality of wireless power transfer apparatuses 260d to the support member. The moving member 220d may drive the plurality of wireless power transfer apparatuses so as to horizontally move on the support member 210d, and the moving member 220 may be controlled by the driving motor 230.

That is, when the unmanned aerial vehicle 100 lands, the charging apparatus 200 may determine whether to align, based on reception power information received from a hall sensor or the unmanned aerial vehicle, and when the alignment is not accurately performed, a controller may perform control in order for a paired plurality of wireless power transfer apparatuses 260d to align with the unmanned aerial vehicle. At this time, at least one apparatus may be selected from among the plurality of wireless power transfer apparatuses 260d and may start charging.

That is, when the unmanned aerial vehicle 100 cannot accurately land due to a GPS error, the wireless charging system for unmanned aerial vehicles according to another embodiment may move the wireless power transfer apparatus, thereby enhancing wireless charging efficiency.

FIG. 11B is a diagram describing a wireless charging system for unmanned aerial vehicles according to another embodiment. Referring to FIG. 11B, except that a configuration of a charging apparatus is modified in comparison with the embodiment of the FIG. 5, a wireless charging system 10 for unmanned aerial vehicles according to another embodiment is the same as the embodiment of the FIG. 5. In describing another embodiment, therefore, detailed descriptions of elements which are the same as or similar to those of the embodiment of FIG. 5 are omitted.

A charging apparatus 200c includes a wireless power transfer apparatus 260c including a transfer coil, a support member 210c, and a moving member 220. In the charging apparatus 200c, four wireless power transfer apparatuses 260a may be disposed on the support member 210c.

The moving member 220 is connected to each of a plurality of the wireless power transfer apparatuses 260c and connects the plurality of wireless power transfer apparatuses 260c to the support member. The moving member 220 may drive the plurality of wireless power transfer apparatuses so as to horizontally move on the support member 210c. The moving member 220 needs a driving element such as a piezoelectric element or a sub-motor and may be easily configured by those skilled in the art, and thus, its detailed description is omitted.

That is, the charging apparatus 200 may horizontally move the plurality of wireless power transfer apparatuses 260c to perform wireless charging, based on a landing point of the unmanned aerial vehicle 100.

That is, when the unmanned aerial vehicle 100 cannot accurately land due to a GPS error, the wireless charging system for unmanned aerial vehicles according to another embodiment may move the wireless power transfer apparatus, thereby enhancing wireless charging efficiency.

The charging apparatus 200 may include a control circuit, which identifies whether a landed object is chargeable or whether charging is completed, and a sensor which senses an abnormal variation of a voltage or a temperature in charging. The charging apparatus 200 may use a carrier current flowing between the wireless power reception apparatus and the wireless power transfer apparatus.

FIG. 12 is a diagram describing a wireless charging system for unmanned aerial vehicles according to another embodiment. Referring to FIG. 12, except that a configuration of a charging apparatus is modified in comparison with the embodiment of the FIG. 5, a wireless charging system 10 for unmanned aerial vehicles according to another embodiment is the same as the embodiment of the FIG. 5. In describing another embodiment, therefore, detailed descriptions of elements which are the same as or similar to those of the embodiment of FIG. 5 are omitted.

Referring to FIGS. 12 (a) and (b), a charging apparatus 200d includes a wireless power transfer apparatus 260d including a transfer coil, a support member 210d, and an electronic textile sensor 230.

The electronic textile sensor 230 may sense whether an unmanned moving vehicle 100 lands on the charging apparatus 200d. The electronic textile sensor 230 may be implemented with an electronic textile, and the electronic textile is a textile which maintains a unique characteristic of a textile itself and has an electrical characteristic. The electronic textile sensor 230 may be applied to various sensors (for example, a non-contact capacitance sensor, a pressure sensor, a temperature sensor, etc.).

The electronic textile sensor 230 may be disposed between the wireless power transfer apparatus 260d and the support member 210d, and the electronic textile sensor 230 may include an electrode layer 230a implemented with a fabric electrode, a connection part 230b electrically connecting electrode layers 230a, a sensing layer 230c implemented with an insulation foam or an insulation sheet, and a support part 230d.

That is, when the unmanned aerial vehicle 100 has landed, the electronic textile sensor 230 may sense weight, and thus, the charging apparatus 200d may sense whether the unmanned aerial vehicle 100 lands and a landing position. The electronic textile sensor 230 may quickly detect a wireless charging target, thereby enhancing charging efficiency.

FIG. 13 is a system block diagram of a charging apparatus according to an embodiment.

Referring to FIG. 13, a charging apparatus 1300 includes a wireless communicator 1340, a sensing unit 1350, a wireless power transfer apparatus 1360, a distance measurer 1370, a power supply 1380, a memory 1390, a controller 1395, and an interface 1397. Elements illustrated in FIG. 13 are not essential in implementing the charging apparatus 1300, and thus, the charging apparatus 1300 described herein may include more or fewer elements than the above-described elements.

The wireless communicator 1340 may include one or more modules which enable wireless communication between the charging apparatus 1300 and a wireless communication system (not shown), between the charging apparatus 1300 and another charging apparatus. Also, the wireless communicator 1340 may include one or more modules which connect the charging apparatus 1300 to one or more networks.

The wireless communicator 1340 may include at least one of a wireless Internet module 1341, a short range communication module 1343, and a position information module 1345. The wireless Internet module 1341 may perform wireless Internet access and may be embedded into or provided outside the charging apparatus 1300. The wireless Internet module 1341 is configured to transmit or receive a wireless signal over a communication network based wireless Internet technologies.

The short range communication module 1343 is for short range communication and may support short range communication by using at least one of Bluetooth™, a radio frequency identification (RFID), infrared data association (IrDA), ultra wideband (UWB), ZigBee, NFC, wireless-fidelity (Wi-Fi), Wi-Fi direct, and wireless universal serial bus (USB). The short range communication module 1343 may support wireless communication between the charging apparatus 1300 and the wireless communication system and between the charging apparatus 1300 and another charging apparatus over a wireless area network. The wireless area network may be a wireless personal area network.

The position information module 1345 is a module for obtaining a position of the unmanned aerial vehicle, and as a representative example, there is a global positioning system (GPS) module or a Wi-Fi module. For example, if the GPS module is used, the charging apparatus 1300 may obtain a position of the charging apparatus 1300 by using a signal transmitted from a GPS satellite. As another example, if the Wi-Fi module is used, the charging apparatus 1300 may obtain a position of the charging apparatus 1300, based on information about a wireless access point (AP) which transmits or receives a wireless signal to or from the Wi-Fi module. The position information module 1345 is a module used to obtain the position of the charging apparatus 1300 and is not limited to a module which directly calculates or obtains the position of the charging apparatus 1300. Furthermore, the charging apparatus 1300 may provide the information about the wireless AP to the unmanned aerial vehicle.

The sensing unit 1350 may include one or more sensors for sensing at least one of internal information about the charging apparatus 1300, ambient environment information about the charging apparatus 1300, and user information. For example, the sensing unit 1350 may include at least one of a proximity sensor 1351, an illumination sensor, a touch sensor, an acceleration sensor, a magnetic sensor, a G-sensor, a gyroscope sensor, a motion sensor, an RGB sensor, an infrared sensor 142, a finger scan sensor, an ultrasonic sensor, an optical sensor, a microphone, a battery gauge, an environment sensor (for example, a barometer, a hygrometer, a thermometer, a radiation sensing sensor, a heat sensing sensor, a gas sensing sensor, etc.), and a chemical sensor (for example, an e-nose, a healthcare sensor, a biometric sensor, etc.). The charging apparatus 1300 disclosed herein may combine and use pieces of information sensed by two or more of the sensors.

The proximity sensor 1351 denotes a sensor which detects an object approaching a certain detection surface or the presence of a nearby object by using a force of an electromagnetic field or infrared light without a mechanical contact. The infrared sensor 1353 is a sensor which detects a distance to an object near the charging apparatus 1300. An electronic textile sensor 1355 may be implemented with the electronic textile sensor 230 illustrated in FIG. 12.

The wireless power transfer apparatus 1360 may be configured identically to the wireless power transfer apparatus 1000 described above with reference to FIGS. 1 to 4.

The distance measurer 1370 may detect a distance to a nearby object in an IR-UWB communication scheme. The IR-UWB communication scheme is short range wireless communication technology having a feature which uses a short pulse of nano second or less without using a carrier, and since the continuous transfer of energy is not performed, the IR-UWB communication scheme may be applied to a wireless positioning system having a sensor network or a high resolution.

That is, the distance measurer 1370 of the charging apparatus 1300 may measure a distance to the unmanned aerial vehicle by using the IR-UWB communication scheme and may provide detected positioning information to the unmanned aerial vehicle to enable the unmanned aerial vehicle to land at an accurate position.

The power supply 1380 receives an external power or an internal power to supply power to each of elements included in the charging apparatus 1300 according to control by the controller 1395.

The memory 1390 stores data which supports various functions of the charging apparatus 1300. The memory 1390 may store a plurality of application programs or applications driven by the charging apparatus 1300 and pieces of data and commands for an operation of the charging apparatus 1300.

The controller 1395 may process a signal, data, information, and the like input or output through the above-described elements or may drive the application program stored in the memory 1390, thereby providing or processing a function or information appropriate for a user.

The interface 1397 act as a path for various kinds of external devices connected to the charging apparatus 1300.

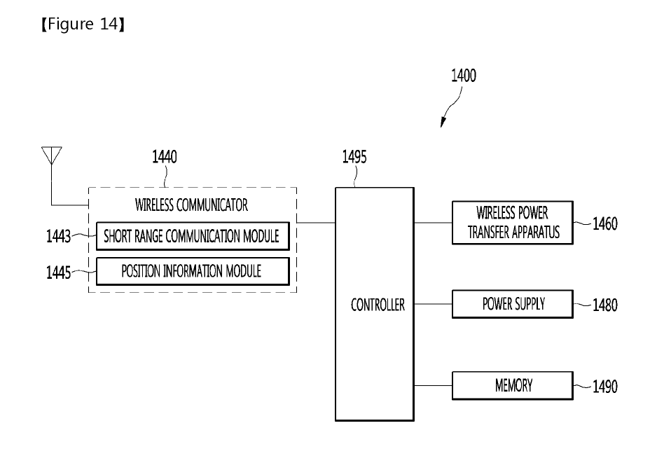

FIG. 14 is a system block diagram of a charging apparatus according to another embodiment. Referring to FIG. 14, a charging apparatus 1400 includes a wireless communicator 1440, a wireless power transfer apparatus 1460, a power supply 1480, and a memory 1490.

The wireless communicator 1440 may include at least one of a short range communication module 1443 and a position information module 1445. The short range communication module 1443 is for short range communication, and the position information module 1445 is a module for obtaining a position of the unmanned aerial vehicle, and as a representative example, there is a global positioning system (GPS) module or a Wi-Fi module. For example, if the GPS module is used, the charging apparatus 1400 may obtain a position of the charging apparatus 1400 by using a signal transmitted from a GPS satellite. As another example, if the Wi-Fi module is used, the charging apparatus 1400 may obtain a position of the charging apparatus 1400, based on information about a wireless access point (AP) which transmits or receives a wireless signal to or from the Wi-Fi module. The short range communication module 1443 may transfer precise position information to the unmanned aerial vehicle 100 to guide landing. The wireless power transfer apparatus 1460 may be configured identically to the wireless power transfer apparatus 1000 described above with reference to FIGS. 1 to 4.

The power supply 1480 receives an external power or an internal power to supply power to each of elements included in the charging apparatus 1400 according to control by the controller 1495.

The memory 1490 stores data which supports various functions of the charging apparatus 1400. The memory 1490 may store a plurality of application programs or applications driven by the charging apparatus 1400 and pieces of data and commands for an operation of the charging apparatus 1400.

FIG. 15 is a flowchart describing a driving method of an unmanned aerial vehicle according to an embodiment.

Referring to FIG. 15, in operation S1510, an unmanned aerial vehicle may move based on received GPS information of a charging apparatus. In operation S1520, the unmanned aerial vehicle may access the charging apparatus to receive a wireless signal including AP information of the charging apparatus. The unmanned aerial vehicle may compare the GPS information with the wireless signal in operation S1530, and when there is a match therebetween, the unmanned aerial vehicle may land based on the GPS information and the wireless signal in operation S1540. After the unmanned aerial vehicle lands, the unmanned aerial vehicle may receive a digital signal from a wireless power transfer apparatus of the charging apparatus and may transfer a reception packet, including reception power information of the unmanned aerial vehicle, to the charging apparatus in operation S1550. The charging apparatus may check the reception power information of the reception packet received from the unmanned aerial vehicle to determine whether a reception coil of the unmanned aerial vehicle aligns with a transfer coil of the charging apparatus, and may notify whether the unmanned aerial vehicle re-lands. That is, the charging apparatus may generate precise position information including a precise position of the transfer coil, based on the reception power information of the reception packet.

The unmanned aerial vehicle may receive the precise position information in operation S1560, and may compare a landing position of the unmanned aerial vehicle with the precise position in operation S1570. If there is a match therebetween, the unmanned aerial vehicle may receive a wireless power in operation S1580, and if there is a mismatch therebetween, the unmanned aerial vehicle may re-land based on the precise position information in operation S1590.

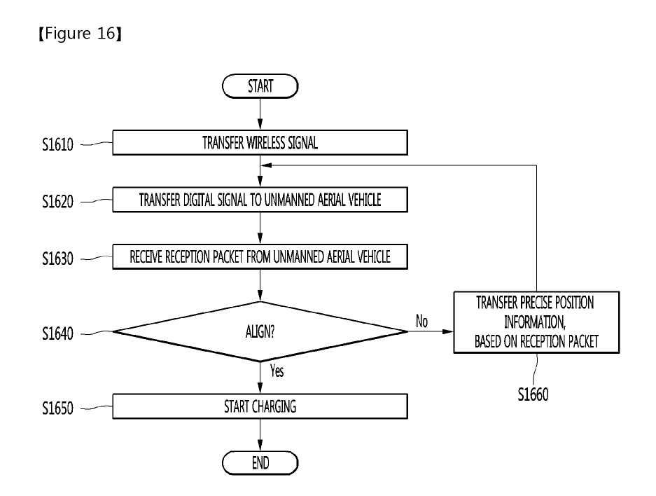

FIG. 16 is a flowchart describing a driving method of a charging apparatus according to an embodiment. Referring to FIG. 16, in a case where a transfer coil of a charging apparatus and a reception coil of an unmanned aerial vehicle match each other in a one-to-one (1:1) relationship, a driving method of the charging apparatus is illustrated.

The charging apparatus may transfer a wireless signal to the unmanned aerial vehicle in operation S1610. The wireless signal may include AP information about an AP where the charging apparatus is located. When the unmanned aerial vehicle has landed, the charging apparatus may transfer a digital signal in operation S1620. The digital signal may include a power beacon, and the power beacon may provide a sufficient power which enables the wireless power reception apparatus to start and respond. In an embodiment, the charging apparatus may transmit the digital signal five times or less for a time of 28 ms or less, and if there is no response of the wireless power reception apparatus, the charging apparatus may return to a standby state.

The charging apparatus may receive a reception packet from the unmanned aerial vehicle in operation S1630. The reception packet may include reception power information, and the charging apparatus may determine whether to align the unmanned aerial vehicle 100, based on the reception power information in operation S1640. For example, if the reception power information included in the reception packet is equal to or greater than a threshold value, a controller of the charging apparatus may determine that the alignment of the unmanned aerial vehicle is completed, and may start charging in operation S1650

If the reception power information included in the reception packet is equal to or less than the threshold value, the controller of the charging apparatus may determine that the alignment of the unmanned aerial vehicle fails, generate precise position information including a precise position of the transfer coil based on the reception power information included in the reception packet, and transfer the precise position information to the unmanned aerial vehicle in operation S1660.

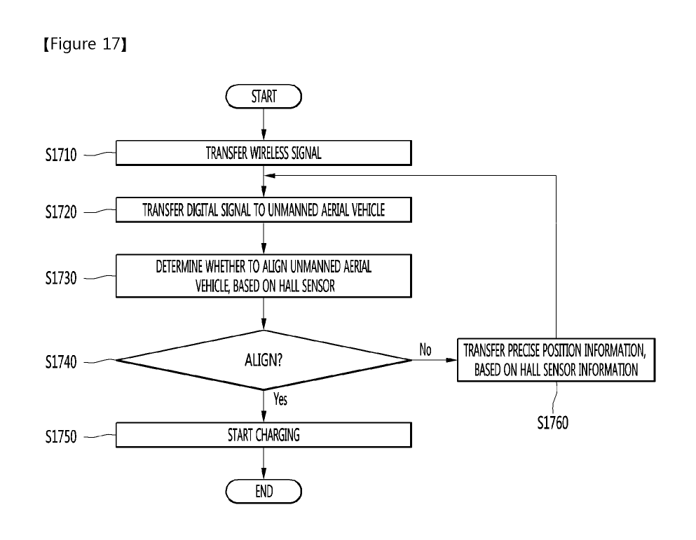

FIG. 17 is a flowchart describing a driving method of a charging apparatus according to another embodiment. Referring to FIG. 17, in a case where a transfer coil of the charging apparatus and a reception coil of an unmanned aerial vehicle match each other in a one-to-one (1:1) relationship, the charging apparatus may guide landing of the unmanned aerial vehicle by using a hall sensor.

The charging apparatus may transfer a wireless signal to the unmanned aerial vehicle in operation S1710. The wireless signal may include AP information about an AP where the charging apparatus is located. The unmanned aerial vehicle may determine a landing point, based on the GPS information and the AP information included in the received wireless signal and may land.

When the unmanned aerial vehicle has landed, the charging apparatus may transfer a digital signal in operation S1720.

In a wireless power transfer apparatus of the charging apparatus, a hall sensor may be disposed inside the transfer coil and may sense a magnetic substance disposed inside the reception coil of a wireless power reception apparatus to determine whether the unmanned aerial vehicle lands and aligns in operation S1730. The hall sensor may sense an intensity of a magnetic flux density of the magnetic substance, and if the intensity of the magnetic flux density of the magnetic substance is equal to or greater than a predetermined threshold value, a controller of the charging apparatus may determine that the landing and alignment are completed for charging the unmanned aerial vehicle, and may perform control to start charging in operation S1750. If the intensity of the magnetic flux density of the magnetic substance is equal to or less than the threshold value, the controller of the charging apparatus may transfer precise position information to the unmanned aerial vehicle to induce re-landing in operation S1760.

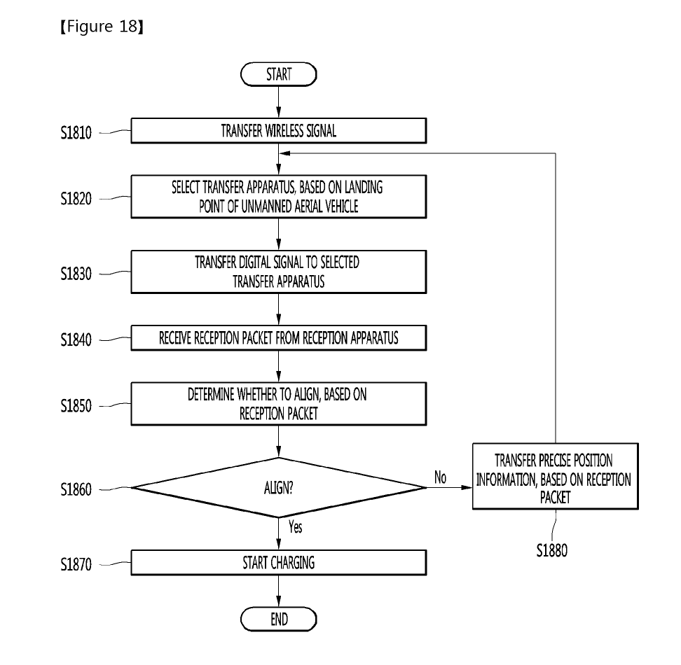

FIG. 18 is a flowchart describing a driving method of a charging apparatus according to another embodiment. Referring to FIG. 18, in a case where a transfer coil of the charging apparatus and a reception coil of the unmanned aerial vehicle match each other in a relationship of n:1, a driving method of the charging apparatus will be described below.

The charging apparatus may transfer a wireless signal to the unmanned aerial vehicle in operation S1810. The wireless signal may include AP information about an AP where the charging apparatus is located. The unmanned aerial vehicle may determine a landing point, based on the GPS information and the AP information included in the received wireless signal and may land.

When the unmanned aerial vehicle has landed, the charging apparatus may select at least one wireless power transfer apparatus from among a plurality of wireless power transfer apparatuses corresponding to a landing point of the unmanned aerial vehicle in operation S1820. The selected wireless power transfer apparatus may transfer a digital signal to a wireless power reception apparatus of the unmanned aerial vehicle in operation S1830.

The charging apparatus may receive a reception packet from the unmanned aerial vehicle in operation S1840. The charging apparatus may determine whether to align the unmanned aerial vehicle, based on reception power information included in the reception packet in operation S1850. For example, if the reception power information included in the reception packet is equal to or greater than a threshold value, a controller of the charging apparatus may determine that the alignment of the unmanned aerial vehicle is completed, and may start charging in operation S1870

If the reception power information included in the reception packet is equal to or less than the threshold value, the controller of the charging apparatus may determine that the alignment of the unmanned aerial vehicle fails, generate precise position information including a precise position of the transfer coil based on the reception power information included in the reception packet, and transfer the precise position information to the unmanned aerial vehicle in operation S1880.

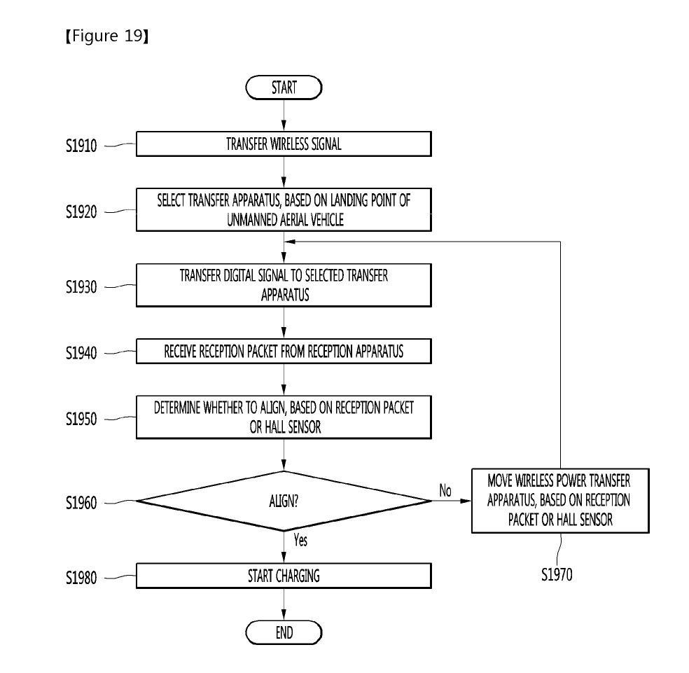

FIG. 19 is a flowchart describing a driving method of a charging apparatus according to another embodiment. Referring to FIG. 19, a driving method of a charging apparatus where a transfer coil of the charging apparatus moves to a landing point of an unmanned aerial vehicle and performs charging will be described below.

The charging apparatus may transfer a wireless signal to the unmanned aerial vehicle in operation S1910. The wireless signal may include AP information about an AP where the charging apparatus is located. The unmanned aerial vehicle may determine a landing point, based on the GPS information and the AP information included in the received wireless signal and may land.

When the unmanned aerial vehicle has landed, the charging apparatus may select at least one wireless power transfer apparatus from among a plurality of wireless power transfer apparatuses corresponding to a landing point of the unmanned aerial vehicle in operation S1920. The selected wireless power transfer apparatus may transfer a digital signal to a wireless power reception apparatus of the unmanned aerial vehicle in operation S1930.

The charging apparatus may receive a reception packet from the unmanned aerial vehicle in operation S1940. The charging apparatus may determine whether to align the unmanned aerial vehicle, based on reception power information included in the reception packet in operation S1950. For example, if the reception power information included in the reception packet is equal to or greater than a threshold value, a controller of the charging apparatus may determine that the alignment of the unmanned aerial vehicle is completed, and may start charging in operation S1980

If the reception power information included in the reception packet is equal to or less than the threshold value, the charging apparatus may determine that the alignment of the unmanned aerial vehicle fails, and may move the selected wireless power transfer apparatus, based on power information included in the reception packet or information sensed by a hall sensor in operation S1970.

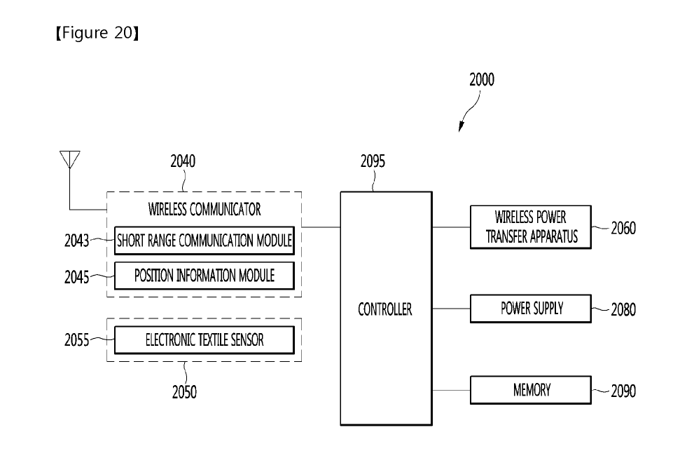

FIG. 20 is a system block diagram of a charging apparatus according to an embodiment. Referring to FIG. 20, a charging apparatus 2000 includes a wireless communicator 2040, a wireless power transfer apparatus 2060, a power supply 2080, and a memory 2090.

The wireless communicator 2040 may include at least one of a short range communication module 2043 and a position information module 2045. The short range communication module 2043 is for short range communication, and the position information module 2045 is a module for obtaining a position of the unmanned aerial vehicle, and as a representative example, there is a global positioning system (GPS) module or a Wi-Fi module. For example, if the GPS module is used, the charging apparatus 2000 may obtain a position of the charging apparatus 2000 by using a signal transmitted from a GPS satellite. As another example, if the Wi-Fi module is used, the charging apparatus 2000 may obtain a position of the charging apparatus 2000, based on information about a wireless access point (AP) which transmits or receives a wireless signal to or from the Wi-Fi module. The short range communication module 2043 may transfer precise position information to the unmanned aerial vehicle to guide landing. The wireless power transfer apparatus 2060 may be configured identically to the wireless power transfer apparatus 1000 described above with reference to FIGS. 1 to 4.

The power supply 2080 receives an external power or an internal power to supply power to each of elements included in the charging apparatus 2000 according to control by the controller 2095.

The memory 2090 stores data which supports various functions of the charging apparatus 2000. The memory 2090 may store a plurality of application programs or applications driven by the charging apparatus 2000 and pieces of data and commands for an operation of the charging apparatus 2000.

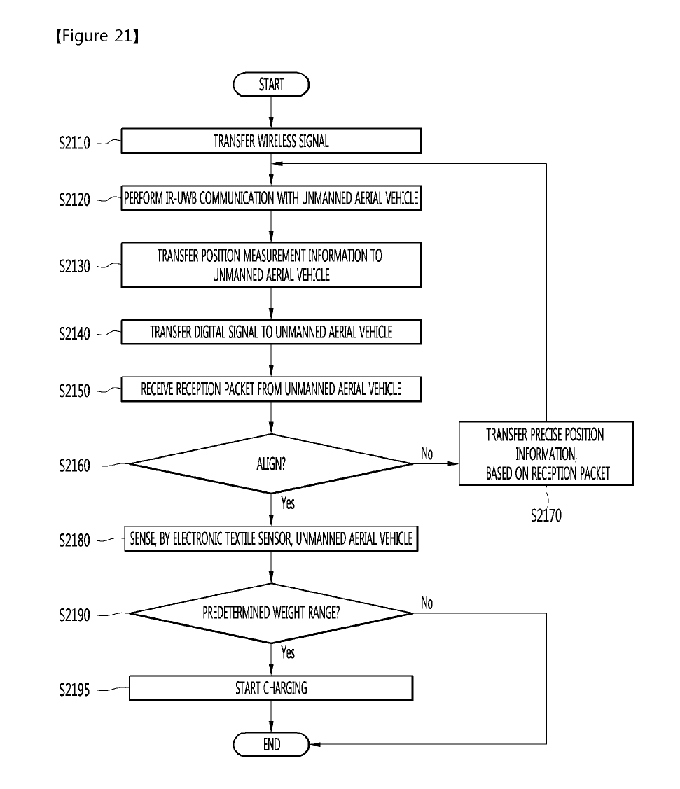

FIG. 21 is a flowchart describing a driving method of a charging apparatus according to an embodiment. Referring to FIG. 21, in a case where a transfer coil of a charging apparatus and a reception coil of an unmanned aerial vehicle match each other in a one-to-one (1:1) relationship, a driving method of the charging apparatus is illustrated.

The charging apparatus may transmit a wireless signal to the unmanned aerial vehicle in operation S2110. The wireless signal may include AP information about an AP where the charging apparatus is located. The charging apparatus may perform IR-UWB communication with the unmanned aerial vehicle in operation S2120, measure a position of the unmanned aerial vehicle to generate position measurement information, and transfer the position measurement information to the unmanned aerial vehicle in operation S2130. The unmanned aerial vehicle may land based on the position measurement information, and after the landing, the charging apparatus may transmit a digital signal to the unmanned aerial vehicle in operation S2140. The digital signal may include a power beacon, and the power beacon may provide a sufficient power which enables the wireless power reception apparatus to start and respond. In an embodiment, the charging apparatus may transmit the digital signal certain times or less (for example, five times) for a time (for example, 28 ms) equal to or less than a predetermined unit time value, and if there is no response of the wireless power reception apparatus, the charging apparatus may return to a standby state.

The charging apparatus may receive a reception packet (a response packet or a signal intensity packet) from the unmanned aerial vehicle in operation S2150. The reception packet may include reception power information, and the charging apparatus may determine whether to align the unmanned aerial vehicle, based on the reception power information in operation S2160. For example, if the reception power information included in the reception packet is equal to or greater than a threshold value, a controller 2195 of the charging apparatus may determine that the alignment of the unmanned aerial vehicle is completed in operation S2160, and the electronic textile sensor of the charging apparatus may sense the unmanned aerial vehicle in operation S2180

If the reception power information included in the reception packet is equal to or less than the threshold value, the controller of the charging apparatus may determine that the alignment of the unmanned aerial vehicle fails, generate precise position information including a precise position of the transfer coil based on the reception power information included in the reception packet, and transfer the precise position information to the unmanned aerial vehicle in operation S2170.

If a weight of a sensed object is within a predetermined weight range, the electronic textile sensor of the charging apparatus may determine the sensed object as the unmanned aerial vehicle and may start charging in operation S2195.

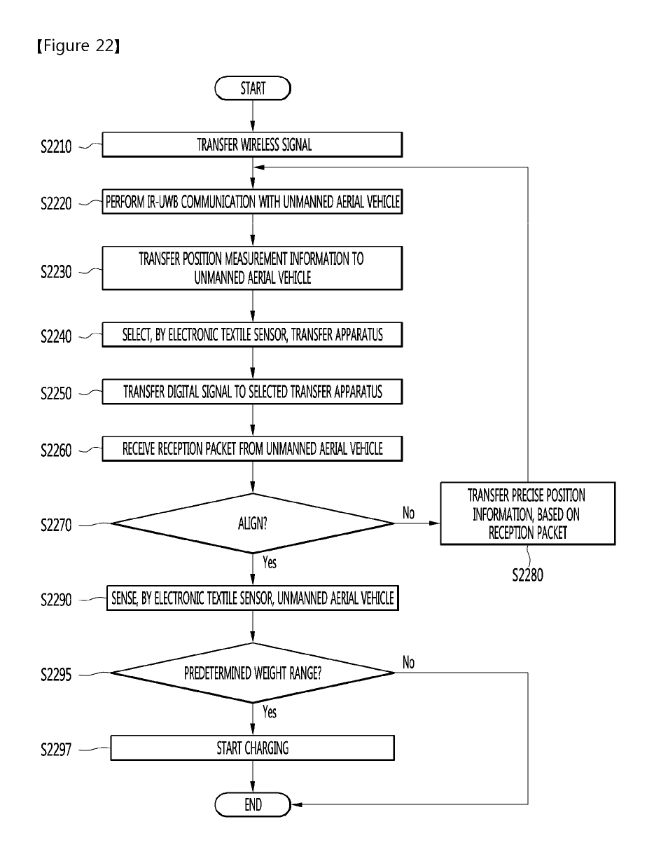

FIG. 22 is a flowchart describing a driving method of a charging apparatus according to another embodiment. Referring to FIG. 22, in a case where a transfer coil of a charging apparatus and a reception coil of an unmanned aerial vehicle match each other in a one-to-one (1:1) relationship, a driving method of the charging apparatus is illustrated.

The charging apparatus may transmit a wireless signal to the unmanned aerial vehicle in operation S2210. The wireless signal may include AP information about an AP where the charging apparatus is located.

The charging apparatus may perform IR-UWB communication with the unmanned aerial vehicle in operation S2220, measure a position of the unmanned aerial vehicle to generate position measurement information, and transfer the position measurement information to the unmanned aerial vehicle in operation S2230. The unmanned aerial vehicle may land based on the position measurement information, and when the unmanned aerial vehicle has landed, the electronic textile sensor of the charging apparatus may sense a weight of the unmanned aerial vehicle and may select at least one wireless power transfer apparatus, corresponding to a landing point of the unmanned aerial vehicle within a predetermined weight range, from among a plurality of wireless power transfer apparatuses in operation S2240. The selected wireless power transfer apparatus may transmit a digital signal to a wireless power reception apparatus of the unmanned aerial vehicle in operation S2250.

The charging apparatus may receive a reception packet from the unmanned aerial vehicle in operation S2260. The charging apparatus may determine whether to align the unmanned aerial vehicle, based on reception power information include in the reception packet in operation S2270. For example, if the reception power information included in the reception packet is equal to or greater than a threshold value, a controller of the charging apparatus may determine that the alignment of the unmanned aerial vehicle is completed in operation S2280, and the electronic textile sensor of the charging apparatus may sense the unmanned aerial vehicle in operation S2290. If a weight of a sensed object is within a predetermined weight range, the electronic textile sensor of the charging apparatus may determine the sensed object as the unmanned aerial vehicle and may start charging in operation S2297.

In another embodiment, the electronic textile sensor may detect an area where a laning unit of the unmanned aerial vehicle lands on a pad. The electronic textile sensor may divide an area of the pad to sense weight. For example, as in the embodiment of FIG. 10, if a plurality of transfer coils are included in the charging apparatus, the electronic textile sensor may sense an area-based weight, based on the plurality of coils. In an operation (S2290) of sensing the unmanned aerial vehicle when landing the unmanned aerial vehicle, the electronic textile sensor may sense an area-based weight, and when a weight of a predetermined area is sensed, the transfer of a wireless power may start by operating a coil corresponding to a corresponding area. Also, if a weight sensing area other than the predetermined area is detected, the charging apparatus may command the unmanned aerial vehicle to perform a re-landing operation. For example, if one transfer coil is included in the charging apparatus as in the embodiment of FIG. 5, the charging apparatus may sense weight around the one coil, and if it is sensed that the landing unit lands outside a corresponding area or in the corresponding area, the charging apparatus may transmit a re-landing operation message to the unmanned aerial vehicle. At this time, a transfer/reception coil may be aligned through re-landing, and then, the charging apparatus may start to transfer a wireless power.

If the reception power information included in the reception packet is equal to or less than the threshold value, the charging apparatus may determine that the alignment of the unmanned aerial vehicle fails, generate precise position information including a precise position of the transfer coil based on the reception power information included in the reception packet, and transfer the precise position information to the unmanned aerial vehicle in operation S2280.

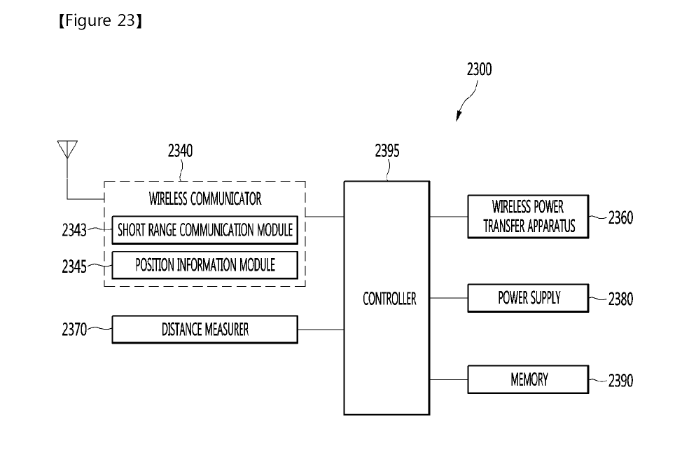

FIG. 23 is a system block diagram of a charging apparatus according to an embodiment. Referring to FIG. 23, a charging apparatus 2300 includes a wireless communicator 2340, a wireless power transfer apparatus 2360, a power supply 2380, and a memory 2390.

The wireless communicator 2340 may include at least one of a short range communication module 2343 and a position information module 2345. The short range communication module 2343 is for short range communication, and the position information module 2345 is a module for obtaining a position of the unmanned aerial vehicle, and as a representative example, there is a global positioning system (GPS) module or a Wi-Fi module. For example, if the GPS module is used, the charging apparatus 2300 may obtain a position of the charging apparatus 2300 by using a signal transmitted from a GPS satellite. As another example, if the Wi-Fi module is used, the charging apparatus 2300 may obtain a position of the charging apparatus 2300, based on information about a wireless access point (AP) which transmits or receives a wireless signal to or from the Wi-Fi module. The short range communication module 2343 may transfer precise position information to the unmanned aerial vehicle to guide landing. The wireless power transfer apparatus 2360 may be configured identically to the wireless power transfer apparatus 1000 described above with reference to FIGS. 1 to 4.

A distance measurer 2370 may detect a distance to an ambient object in an IR-UWB communication scheme. The IR-UWB communication scheme is short range wireless communication technology having a feature which uses a short pulse of a nano-second or less without using a carrier, and since continuous energy transfer is not performed, ultra-low power communication is possible, and the IR-UWB communication scheme may be used in a wireless positioning system having a high resolution or a sensor network.

That is, the charging apparatus 2300 may measure a distance to the unmanned aerial vehicle by using the distance measurer 2370 in the IR-UWB communication scheme and may provide detected position measurement information to the unmanned aerial vehicle to help the unmanned aerial vehicle land at an accurate position.

The power supply 2380 receives an external power or an internal power to supply power to each of elements included in the charging apparatus 2300 according to control by the controller 2395.

The memory 2390 stores data which supports various functions of the charging apparatus 2300. The memory 2390 may store a plurality of application programs or applications driven by the charging apparatus 2300 and pieces of data and commands for an operation of the charging apparatus 2300.

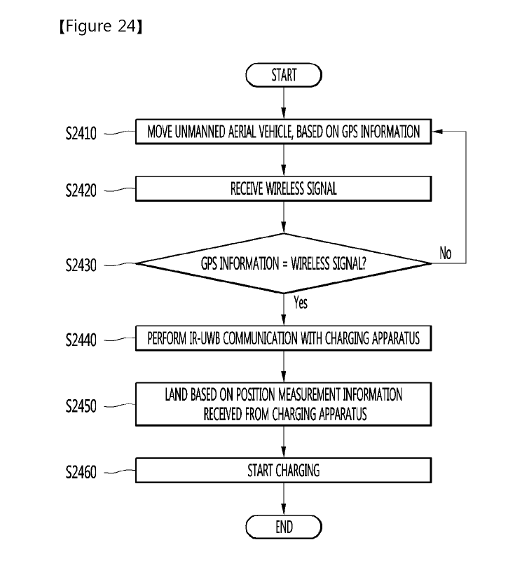

FIG. 24 is a flowchart describing a driving method of an unmanned aerial vehicle according to an embodiment.

Referring to FIG. 15, in operation S2410, an unmanned aerial vehicle may move based on received GPS information of a charging apparatus. In operation S2420, the unmanned aerial vehicle may access the charging apparatus to receive a wireless signal including AP information of the charging apparatus. The unmanned aerial vehicle may compare the GPS information with the wireless signal in operation S2430, and when there is a match therebetween, the unmanned aerial vehicle may perform IR-UWB communication with the charging apparatus in operation S2440, and may land based on the GPS information and the wireless signal in operation S2450. In another embodiment, without comparing the GPS information with the wireless signal, the unmanned aerial vehicle may compare pre-stored charging apparatus identification information with identification information included in the wireless signal to identify the charging apparatus in operation S2430. After identification, the driving method performs the IR-UWB communication operation (S2440) which is a next operation, and the unmanned aerial vehicle is induced to perform precise landing. The precise landing denotes a landing induction method of aligning a wireless power reception coil of the unmanned aerial vehicle and a wireless power transfer coil of the charging apparatus. The unmanned aerial vehicle may receive a wireless charging power from a wireless power transfer apparatus of the charging apparatus to start charging in operation S2460.

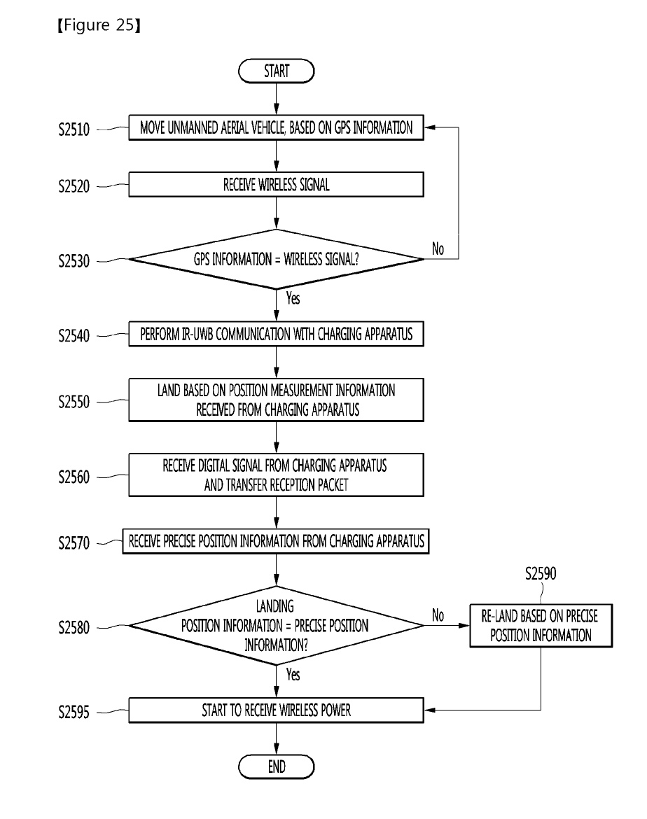

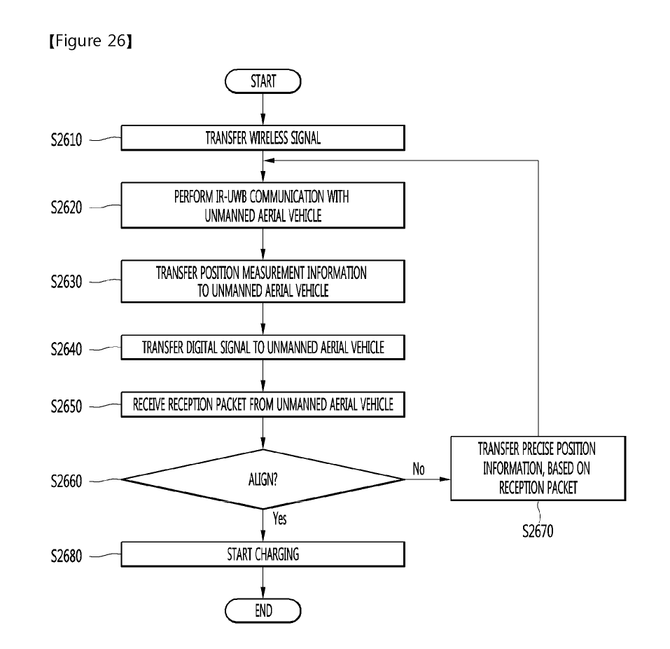

FIG. 25 is a flowchart describing a driving method of an unmanned aerial vehicle according to another embodiment.

Referring to FIG. 25, in operation S2510, an unmanned aerial vehicle may move based on received GPS information of a charging apparatus. In operation S2520, the unmanned aerial vehicle may access the charging apparatus to receive a wireless signal including AP information of the charging apparatus. The unmanned aerial vehicle may compare the GPS information with the wireless signal in operation S2530, and when there is a match therebetween, the unmanned aerial vehicle may perform IR-UWB communication with the charging apparatus in operation S2540, and may land based on the GPS information and the wireless signal in operation S2550. In another embodiment, without comparing the GPS information with the wireless signal, the unmanned aerial vehicle may compare pre-stored charging apparatus identification information with identification information included in the wireless signal to identify the charging apparatus (S2530). After identification, the driving method performs the IR-UWB communication operation (S2540) which is a next operation, and the unmanned aerial vehicle is induced to perform precise landing. The precise landing denotes a landing induction method of aligning a wireless power reception coil of the unmanned aerial vehicle and a wireless power transfer coil of the charging apparatus. After the unmanned aerial vehicle lands, the unmanned aerial vehicle may receive a digital signal from a wireless power transfer apparatus of the charging apparatus and may transfer a reception packet, including reception power information of the unmanned aerial vehicle, to the charging apparatus in operation S2560. The charging apparatus may check the reception power information of the reception packet received from the unmanned aerial vehicle to determine whether a reception coil of the unmanned aerial vehicle aligns with a transfer coil of the charging apparatus, and may notify whether the unmanned aerial vehicle re-lands. That is, the charging apparatus may generate precise position information including a precise position of the transfer coil, based on the reception power information of the reception packet.

The unmanned aerial vehicle may receive the precise position information in operation S2570, and may compare a landing position of the unmanned aerial vehicle with the precise position in operation S2580. If there is a match therebetween, the unmanned aerial vehicle may receive a wireless power in operation S2595, and if there is a mismatch therebetween, the unmanned aerial vehicle may re-land based on the precise position information in operation S2590.

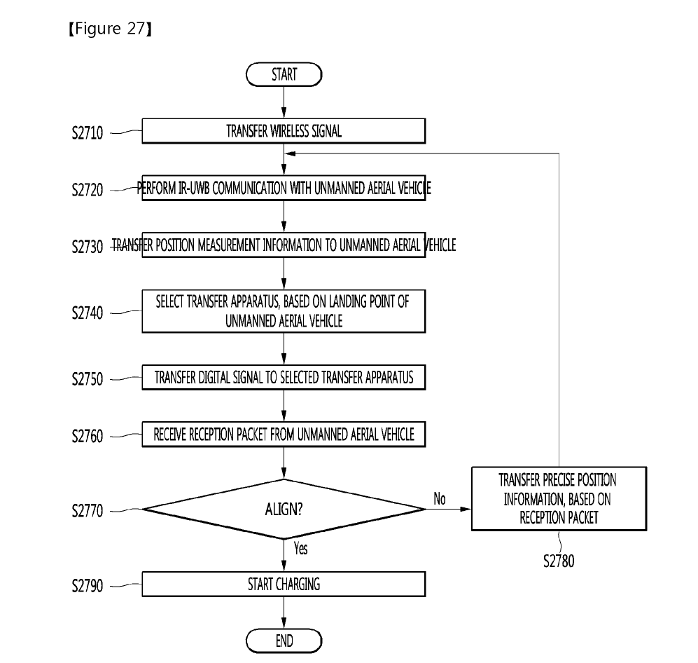

FIG. 26 is a flowchart describing a driving method of a charging apparatus according to an embodiment. Referring to FIG. 26, in a case where a transfer coil of a charging apparatus and a reception coil of an unmanned aerial vehicle match each other in a one-to-one (1:1) relationship, a driving method of the charging apparatus is illustrated.

The charging apparatus may transmit a wireless signal to the unmanned aerial vehicle in operation S2610. The wireless signal may include AP information about an AP where the charging apparatus is located. The charging apparatus may perform IR-UWB communication with the unmanned aerial vehicle in operation S2620, measure a position of the unmanned aerial vehicle to generate position measurement information, and transfer the position measurement information to the unmanned aerial vehicle in operation S2630. The unmanned aerial vehicle may land based on the position measurement information, and after the landing, the charging apparatus may transmit a digital signal to the unmanned aerial vehicle in operation S2640. The digital signal may include a power beacon, and the power beacon may provide a sufficient power which enables the wireless power reception apparatus to start and respond. In an embodiment, the charging apparatus may transmit the digital signal certain times or less (for example, five times) for a time (for example, 28 ms) equal to or less than a predetermined unit time value, and if there is no response of the wireless power reception apparatus, the charging apparatus may return to a standby state.

The charging apparatus may receive a reception packet (a response packet or a signal intensity packet) from the unmanned aerial vehicle in operation S2650. The reception packet may include reception power information, and the charging apparatus may determine whether to align the unmanned aerial vehicle, based on the reception power information in operation S2660. For example, if the reception power information included in the reception packet is equal to or greater than a threshold value, a controller of the charging apparatus may determine that the alignment of the unmanned aerial vehicle is completed, and may start charging in operation S2680

If the reception power information included in the reception packet is equal to or less than the threshold value, the controller of the charging apparatus may determine that the alignment of the unmanned aerial vehicle fails, generate precise position information including a precise position of the transfer coil based on the reception power information included in the reception packet, and transfer the precise position information to the unmanned aerial vehicle in operation S2670. Accordingly, the unmanned aerial vehicle may perform a re-landing operation.

FIG. 27 is a flowchart describing a driving method of a charging apparatus according to another embodiment. Referring to FIG. 27, in a case where a transfer coil of a charging apparatus and a reception coil of an unmanned aerial vehicle match each other in a one-to-one (1:1) relationship, a driving method of the charging apparatus is illustrated.

The charging apparatus may transmit a wireless signal to the unmanned aerial vehicle in operation S2710. The wireless signal may include AP information about an AP where the charging apparatus is located.

The charging apparatus may perform IR-UWB communication with the unmanned aerial vehicle in operation S2720, measure a position of the unmanned aerial vehicle to generate position measurement information, and transfer the position measurement information to the unmanned aerial vehicle in operation S2730. The unmanned aerial vehicle may land based on the position measurement information, and when the unmanned aerial vehicle has landed, the electronic textile sensor of the charging apparatus may sense a weight of the unmanned aerial vehicle and may select at least one wireless power transfer apparatus, corresponding to a landing point of the unmanned aerial vehicle within a predetermined weight range, from among a plurality of wireless power transfer apparatuses in operation S2740. The selected wireless power transfer apparatus may transmit a digital signal to a wireless power reception apparatus of the unmanned aerial vehicle in operation S2750.

The charging apparatus may receive a reception packet (a response packet or a signal intensity packet) from the unmanned aerial vehicle in operation S2760. The charging apparatus may determine whether to align the unmanned aerial vehicle, based on reception power information include in the reception packet in operation S2770. For example, if the reception power information included in the reception packet is equal to or greater than a threshold value, a controller of the charging apparatus may determine that the alignment of the unmanned aerial vehicle is completed, and may start charging in operation S2790.

If the reception power information included in the reception packet is equal to or less than the threshold value, the charging apparatus may determine that the alignment of the unmanned aerial vehicle fails, generate precise position information including a precise position of the transfer coil based on the reception power information included in the reception packet, and transfer the precise position information to the unmanned aerial vehicle in operation S2780.

The above detailed descriptions should not be restrictively construed at all points and should be considered as examples. The scope of the present invention should be determined by rational interpretation of attached claims, and all modifications are included in the scope of the present invention within an equivalent range.

### INDUSTRIAL APPLICABILITY

The present invention may be used in the wireless power transfer field.

1. A driving method of an unmanned aerial vehicle receiving a wireless charging power from a charging apparatus, the driving method comprising:
moving, by the unmanned aerial vehicle, based on GPS information and receiving a wireless signal, including position information about the charging apparatus, from the charging apparatus;
determining whether the GPS information matches the position information included in the wireless signal and landing based on the GPS information and the wireless signal; and
transferring, to the charging apparatus, a reception packet including power information about the unmanned aerial vehicle and receiving precise position information including position coordinates of the charging apparatus generated based on the reception packet.

2. The driving method of claim 1, further comprising comparing the precise position information with landing position information about the unmanned aerial vehicle, and when the precise position information matches the landing position information, receiving the wireless charging power.

3. The driving method of claim 1, further comprising comparing the precise position information with landing position information about the unmanned aerial vehicle, and when the precise position information does not match the landing position information, re-landing, by the unmanned aerial vehicle, based on the precise position information.

4. The driving method of claim 1, further comprising, when the power information is greater than a threshold value, performing control to turn off a driver power, based on the reception packet including the power information.

5. The driving method of claim 1, wherein the unmanned aerial vehicle comprises:
a body part;
a wing part including connected to the body part, the wing part including a plurality of propellers; and
a leg part equipped with a wireless power reception apparatus receiving the wireless charging power from the charging apparatus.

6. The driving method of claim 5, wherein a size and a shape of a reception coil of the wireless power reception apparatus are the same as a size and a shape of a transfer coil of the charging apparatus.

7. A driving method of a charging apparatus transferring a wireless charging power to an unmanned aerial vehicle, the driving method comprising:
transferring a wireless signal including AP information about the charging apparatus to the unmanned aerial vehicle;
sensing the unmanned aerial vehicle to transfer a digital signal and receiving a reception packet from the unmanned aerial vehicle; and
determining whether to align, based on reception power information of a wireless power reception apparatus included in the reception packet.

8. The driving method of claim 7, further comprising, when the reception packet is greater than a threshold value, charging the unmanned aerial vehicle with a wireless power.

9. The driving method of claim 7, further comprising, when the reception packet is equal to or less than a threshold value, generating precise position information including position coordinates of the charging apparatus, based on the reception packet and transferring the generated precise position information to the unmanned aerial vehicle.

10. The driving method of claim 7, further comprising selecting at least one wireless power transfer apparatus corresponding to a landing point of the unmanned aerial vehicle from among a plurality of wireless power transfer apparatuses.

11. The driving method of claim 8, further comprising, when the reception packet is equal to or less than a threshold value, generating precise position information including position coordinates of the charging apparatus, based on the reception packet or information sensed by a hall sensor of the charging apparatus and transferring the generated precise position information to the unmanned aerial vehicle.

12. The driving method of claim 7, wherein the charging apparatus comprises:
a wireless power transfer apparatus including a coil;
a controller generating precise position information including position coordinates of the charging apparatus, based on the reception packet; and
a wireless communicator transferring the precise position information to the unmanned aerial vehicle.

13. The driving method of claim 12, wherein when the unmanned aerial vehicle fails to align, the controller performs control to horizontally move a paired plurality of wireless power transfer apparatuses.

14. A driving method of a charging apparatus transferring a wireless charging power to an unmanned aerial vehicle, the driving method comprising:
transferring a wireless signal including AP information about the charging apparatus to the unmanned aerial vehicle;
performing IR-UWB communication with the unmanned aerial vehicle to measure a position of the unmanned aerial vehicle;
transferring position measurement information and a digital signal to the unmanned aerial vehicle and receiving a reception packet from the unmanned aerial vehicle;
determining whether to align, based on reception power information of a wireless power reception apparatus included in the reception packet; and
sensing, by an electronic textile sensor of the charging apparatus, the unmanned aerial vehicle.

15. The driving method of claim 14, further comprising:
performing IR-UWB communication with the charging apparatus and landing based on the position measurement information received from the charging apparatus.

16. The driving method of claim 14, further comprising, when the reception packet is greater than a threshold value, charging the unmanned aerial vehicle with a wireless power.

17. The driving method of claim 14, further comprising, when the reception packet is equal to or less than a threshold value, generating precise position information including position coordinates of the charging apparatus, based on the reception packet and transferring the generated precise position information to the unmanned aerial vehicle.

18. The driving method of claim 14, further comprising, when the reception packet is equal to or less than a threshold value, generating precise position information including position coordinates of the charging apparatus, based on the reception packet or information sensed by a hall sensor of the charging apparatus and transferring the generated precise position information to the unmanned aerial vehicle.

19. The driving method of claim 14, wherein the charging apparatus measures a distance to the unmanned aerial vehicle through IR-UWB communication.

20. The driving method of claim 14, further comprising, when the power information is greater than a threshold value, performing control to turn off a driver power, based on the reception packet including the power information.
